(19) United States
(12) Patent Application Publication
(10) Pub. No.: US 2008/0044651 A1
(43) Pub. Date: Feb. 21, 2008

(54) Coatings Comprising Carbon Nanotubes

(75) Inventor: Joel S. Douglas, Groton, CT (US)

Correspondence Address: Wayne R. Grohs, 66 Neptune Drive, Groton, CT, 06340, US

(73) Assignee: MYSTICMD INC., Groton, CT (US)

(21) Appl. No.: 11/579,750

(22) PCT Filed: May 31, 2005
(86) PCT No.: PCT/US05/19311

§ 371 Date: Aug. 10, 2007

Related U.S. Application Data
(60) Provisional application No. 60/576,195, filed on Jun. 2, 2004.

(51) Int. Cl. C09D 11/00

(52) U.S. Cl. 428/339; 106/31.92; 106/472; 427/122

(57) ABSTRACT

An electrically conductive coating is disclosed. According to one embodiment of the present invention, the coating includes a plurality of single-wall or multi-walled Carbon nanotubes having a diameter less than 20 nanometers. The disclosed coating demonstrates excellent conductivity and smooth surface morphology. Methods of preparing the coating as well as methods of its use are also disclosed herein.

### CROSS REFERENCE TO RELATED APPLICATIONS

This application claims priority to U.S. Provisional Application No. 60/576,195, filed on Jun. 2, 2004, entitled Coatings Comprising Carbon Nanotubes and Antimony-Tin Oxide, the disclosure of which is incorporated herein by reference in its entirety.

### FIELD OF THE INVENTION

The present invention relates to electrically conductive coatings, dyes and inks formed from conductive dispersions. More particularly, the invention relates to low solids concentration electrically conductive coatings, dyes and inks comprised of carbon nanotubes, dispersions of carbon nanotubes and conductive oxides, and to composite coatings formed from dispersions of carbon nanotubes, conductive metal oxide and polymer binders. The conductive carbon nanotube layer is formed by depositing the coating, dye or ink containing carbon nanotube dispersion onto a non conductive substrate.

### BACKGROUND OF THE INVENTION

Electrically conductive ink and coatings are known in the art. In general, such conductive coatings are formed on an electrical insulating non conductive substrate by either a dry or a wet process. In the dry process, Physical Vapor Deposition (PVD) (including sputtering, ion plating and vacuum deposition) or Chemical Vapor Deposition (CVD) is used to form a conductive transparent coating of a metal oxide type that has a smooth surface morphology, e.g., tin-indium mixed oxide (ITO), antimony-tin mixed oxide (ATO), fluorine-doped tin oxide (FTO), aluminum-doped zinc oxide (FZO). In the wet process, a conductive coating composition is formed using an electrically conductive powder, e.g., one of the above-described mixed oxides and a binder which forms dispersion. The dry process produces a conductive coating that has translucent capabilities, smooth surface morphology and good conductivity. However, the dry process requires a complicated apparatus having a vacuum system and deposition process and does not permit the real time marking of a substrate because of the need to be done in a vacuum. Equipment from manufacturers such as CVD Equipment Corporation, Ionbond equipment or Ulvac can be used to produce roll coated depositions of conductive film products. An excellent reference on materials and process for fabricating electronic components is Charles A. Harper, Handbook of Materials and Processes for Electronics, 1984, Library of Congress card number 76-95803. It provides detailed process information on thick conductive ink and coating, thin conductive ink and coating and photo resist processes. As described in the textbook Handbook of Materials and Processes for Electronics, dry process fabrication of electrically conductive inks and coatings is difficult to apply to a continuous or large substrate such as in a large converting process because of the cost of forming the vacuum chambers.

The wet process requires a relatively simple apparatus, has high productivity, and is easy to apply to a continuous or large substrate. In addition it can be converted using traditional converting processes such as those found in the text book Flexography, Principles and Practices, Library of Congress Card No. 80-69506. The selected electrically conductive powder used in the wet process is a very fine powder usually having an average primary particle diameter of 0.5 um or less so as not to interfere with translucent qualities and produce an ink or coating that has a has a relatively smooth surface morphology. To obtain a translucent coating or conductive ink and coating that has a smooth surface morphology, the conductive powder will be formed from conductive powders having an average particle diameter of half or less (0.2 um (micro meter)) of the shortest wave of visible light so as not to absorb visible light, and to control scattering of the visible light. A typical commercially available ink product is the conductive dispersion such as Acheson Electrodag 427 Antimony Tin Oxide (ATO) dispersion. This dispersion has a high solids concentration that creates a rougher surface texture to achieve higher conductivity due to the need to increase the concentration of conductive particles, which also results in low translucent properties.

A significant discovery and improvement in the creation of conductive inks, dyes and coatings was that of carbon nanotubes, which are essentially single graphite layers wrapped into tubes, either single walled nanotubes, double walled (DWNTs) or multi walled (MWNTs) wrapped in several concentric layers. (B. I. Yakobson and R. E. Smalley, “Fullerene Nanotubes: C.sub.1,000,000 and Beyond”, American Scientist v.85, July-August 1997). Although only first widely reported in 1991, (Phillip Ball, “Through the Nanotube”, New Scientist, Jul. 6, 1996, p. 28-31.) carbon nanotubes are now readily synthesized in gram quantities in laboratories all over the world, and are also being offered commercially by such companies as Mitsui or Helix Material Solutions, Inc. The tubes have good intrinsic electrical conductivity and have been used to form conductive materials.

U.S. Pat. No. 5,853,877, the disclosure of which is incorporated herein by reference in its entirety, relates to the use of chemically modified multi-walled nanotubes (MWNT). The coating and conductive inks and coatings disclosed in U.S. Pat. No. 5,853,877 are optically transparent and smooth surface morphologies when formed as a very thin layer. However, the thin layer embodiments have limited conductive properties. As the thickness of the conductive ink and coatings increases to greater than about 5 um to increase the conductive property, the conductive ink and coatings lose their transparent optical properties and smooth surface morphologies when compared to polyester substrate which has a surface roughness of approximately 40 nm using an Optical Profilometer. The loss of these properties limits the usefulness of the resulting conductive coatings for those applications requiring good translucent and smooth surface morphology properties such as devices used in co-pending provisional applications U.S. 60/546,762 strip electrode with conductive nanotube printing and U.S. 60/652,111 Taser personnel armor and co-pending application Ser. No. 11/029,270 Security marking and security mark, the disclosures of which are incorporated herein by reference in their entirety.

U.S. Pat. No. 5,853,877 also relates to conductive ink and coatings that are formed with and without binders. The conductive ink and coatings include binders with a very high nanotube concentration and are extremely thin in order to maintain the optical properties desired. For example, the patent discloses a conductive ink and coating with 40% wt MWNT loading to get good ESD conductivities. However the clarity and smoothness of the surface morphology is limited by the high percentage of MWNT in the conductive ink and coating which makes the coating appear grey to black and the surface roughness is 384 nm using an Optical Profilometer.

U.S. Pat. No. 5,908,585, the disclosure of which is incorporated herein by reference in its entirety, relates to the use of two conductive additives, both MWNT and an electrically conductive metal oxide powder and the surface roughness is 390 nm using an Optical Profilometer.

### SUMMARY OF THE INVENTION

Therefore, a need has arisen for an electrically conductive translucent ink, dyes or coating comprised of conductive materials formed from a dispersion with low solids concentrations and that will form a smooth surface morphology after it is applied to a substrate and cured. The conductive translucent ink, dyes or coating formed by using carbon nanotubes that overcome the problems of rough surface morphologies caused by high solids concentrations found in conductive coatings manufactured from methods described in the related prior art minimize discoloration and surface texture roughness of the cured conductive ink, dyes or coating.

This invention relates to conductive inks and coatings made from dispersions with a low solids concentration. The conductive inks and coatings are used to form a conductive layer made of carbon nanotubes and alloyed with other conductive and non conductive materials to achieve the desired results. The conductive and non conductive materials include carbon nanotubes, carbon nanotubes/antimony tin oxide, carbon nanotubes/platinum, or carbon nanotubes/silver or carbon nanotubes/silver-chloride and communicate electrically with conductive ink or conductive carbon nanotubes, carbon nanotubes/antimony tin oxide, carbon nanotubes/platinum, or carbon nanotubes/silver or carbon nanotubes/silver-chloride on the substrate.

The invention creates conductive inks, dyes and coatings made from dispersions that result in a very smooth surface morphology after they are applied to a substrate and cured. This permits the formation of the cured conductive inks, dyes and coatings having surface textures less than 40 nm using an Optical Profilometer which are formed from nano size particles and produce smooth and virtually transparent coatings and inks. The coating, dyes or ink are formed from a conductive carbon nanotube dispersion which includes as part of the formulation carbon nanotubes, carbon nanotubes/antimony tin oxide, carbon nanotubes/platinum, or carbon nanotubes/silver or carbon nanotubes/silver-chloride. These dispersions as part of a conductive ink, dyes or coating when applied to a non conductive surface and cured allow the production of a very repeatable surface that is conductive, translucent and has a very smooth surface morphology. The dispersions of the invention form conductive inks and coatings with a differential surface morphology roughness less than 100 nano meters when compared to the base substrate which is significantly smoother than current printed ink technologies which are designed as dispersions of finely divided graphite, silver or silver chloride particles in a thermoplastic resin and contain solids in the range Of 20% to 60%. These particles tend to be at least 100 microns to 10 microns in diameter and result in a surface roughness in the 1-2 micron range. The carbon nanotube conductive inks formed from dispersions of the invention have the same conductive capacity and have solids contents of 2-3% and the particle size is less than 20 nanometers. Compared to conventional inks, this is 500 times smaller than the 10 micron particle, the surface roughness is 28 times smoother and the solid content is between 6 and 20 times less.

The coatings, inks and dyes made can be made from dispersions of single wall or multi wall carbon nanotubes preferably sized to be less than 20 nm and greater than 0.5 nm in outer dimension size. Additionally, conductive dispersions such as Acheson Electrodag 427 Antimony Tin Oxide (ATO) ink can be alloyed with either single wall or multi wall carbon nanotubes preferably sized to be greater than 0.5 nm and less than 20 nm in outer dimension size. The carbon nanotubes are mixed uniformly into the Acheson Electrodag 427 such that the percent by weight is between 0.5 to 10%. Preferably the carbon nanotubes are added such that they make up 3% by weight of the mixture. Additionally platinum nano particles can be added and mixed uniformly to the coating or ink such that the percent by weight is between 0.5 to 10%. Preferably the nano size platinum particles are added such that they make up 4% by weight of the mixture. Each of the above references is incorporated herein by reference in its entirety. The resulting coating or ink thicknesses when applied to a substrate are between about 0.5 nm to about 1000 microns

Any of the aforementioned coatings, dyes or inks made from the dispersion of the invention result in improved electrical conductivity with surface resistance in the range of less than about 100,000 ohms/square, differentially smooth surface morphologies between 10 to 100 nm when compared to the surface roughness of the base material, total light transmittance of greater than 60 after being applied to a non conductive substrate and properly cured.

The preferred embodiment includes the following features: a conductive carbon nanotube layer formed by coating the substrate with a conductive carbon nanotube dispersion. The dispersions can be made from single wall or multi wall carbon nanotubes preferably sized to be less than 20 nm and greater than 0.5 nm in outer dimension size. Additionally, conductive dispersions such as Acheson Electrodag 427 Antimony Tin Oxide (ATO) ink can be alloyed with either single wall or multi wall carbon nanotubes preferably sized to be greater than 0.5 nm and less than 20 nm in size to achieve a coating that allows for improved differential surface morphology when compared to the base material which permits the formation of a differential surface roughness less than 100 nm using an Optical Profilometer and results in improved translucent properties. The carbon nanotubes are mixed uniformly into the Acheson Electrodag 427 such that the percent by weight is between 0.5 to 10%. Preferably the carbon nanotubes are added such that they make up 3% by weight of the mixture. Additionally platinum nano particles can be added and mixed uniformly to the coating such that the percent by weight is between 0.5 to 10%. Preferably the nano size platinum particles are added such that they make up 4% by weight of the mixture.

Alternatively a non conductive binder can be used to form the conductive coating, dyes or ink. The small size of the carbon nanotubes permits the formation of a differential surface roughness less than 100 nm using an Optical Profilometer when compared to the base substrate for these conductive coatings or inks. The carbon nanotubes knit together to form a conductive surface after the dispersion is applied to a substrate and cured and the overlaying of the polymer binder provides a porous layer that allows the passage of the electrons. The polymer binder is not conductive: therefore the coating laid down in the first step is the only conductive path. The non conductive polymer binder is used to coat the conductive ink and protect it from wear. The polymeric material is selected from the group consisting of thermoplastics, thermosetting polymers, elastomers, conducting polymers and combinations thereof. These polymeric material can be selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof, or ceramic hybrid polymers, Ethylene Glycol Monobutl Ether Acetate, phosphine oxides and chalcogenides.

Additionally when a dispersion of the present invention is used for devices used in co-pending provisional applications U.S. 60/546,762 strip electrode with conductive nanotube printing and U.S. 60/652,111 Taser personnel armor, and co-pending application Ser. No. 11/029,270 Security marking and security mark, the improved surface morphology increases the wear ability of the resulting coating, decreases electrochemical variation, and improves the translucent properties of the coating. These coatings are not clear or transparent but provide a translucent formation with very high conductive properties with good physical properties including improved surface morphologies over existing coatings and inks.

In a preferred embodiment of the invention, the conductive coating, dyes and inks created from the dispersions provide electrostatic dissipative coatings with smooth surface morphologies and translucent features that are comprised of nanotubes, metal oxides, carbon, and metals.

In another preferred embodiment, the invention provides an electrically conductive inks, dyes and coatings formed from dispersions comprising: a plurality of carbon nanotubes with an outer diameter of less than 20 nm.

In another preferred embodiment, the invention provides a method for making electrically conductive inks, dyes and coatings formed from a dispersion comprising of a plurality of carbon nanotubes with an outer diameter preferably less than 10 nm; and forming a conductive coating, dyes or ink of said nanotubes on a surface of a non conductive substrate.

In another preferred embodiment, the invention provides a multi-layered structure comprised of electrically conductive inks, dyes and coatings formed from a dispersion, and a polymeric layer disposed on at least a portion of said electrically conductive inks and coatings.

In another preferred embodiment, the invention provides a multi-layered structure comprising electrically conductive inks, dyes and coatings formed from a dispersion and a polymeric layer disposed on at least a portion of said electrically conductive inks and coatings that is in communication with a semi conductive substrate.

In another preferred embodiment, the invention provides dispersions of carbon nanotubes suitable for forming conductive inks, dyes and coatings and other compositions. Such compositions may contain additional conductive, partially conductive or non-conductive materials. The presence of nanotubes reduces the manufacturing costs of conventional materials that do not contain nanotubes while increasing conductivity and increasing the translucent properties of the resulting dispersion compared to dispersions made from alternative conductive materials. Compositions may be in any form such as a solid or liquid, and is preferably a powder, a coating, an emulsion, or mixed dispersion.

In another preferred embodiment, the invention provides dispersions of carbon nanotubes suitable for forming conductive dyes. Such dyes may contain additional conductive, partially conductive or non-conductive materials. The presence of nanotubes induces conductive properties to the dyes, which are not normally possible with conventional dyes that do not contain nanotubes. Due to the translucent nature of the ink of the resulting carbon nanotube dispersion, the carbon nanotubes do not impair the coloration properties of the dye. The carbon nanotubes when mixed with the dye base and the mixture is applied to a bibulous or absorbent fiber preferentially adhere to the outer diameter of the fiber forming a conductive mat around the fiber. Dyes formed from this process may be in any form such as a solid or liquid, and is preferably a powder, a coating, an emulsion, or mixed dispersion.

Other objects, features and advantages of the present invention will become apparent from the following detailed description. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The accompanying drawings, which are incorporated and constitute a part of the specification, illustrate preferred embodiments of the invention and, together with the general description given above and the detailed description of the preferred embodiments given below, serve to explain the principles of the invention. Thus, for a more complete understanding of the present invention, the objects and advantages thereof, reference is now made to the following descriptions taken in connection with the accompanying drawings in which:

FIG. 1 is a picture of a carbon nanotube mat formed by curing.

FIG. 2 shows CNT inks or dispersion coated on Polyester.

FIG. 3 is a two part CNT ink or dispersion.

FIG. 4 shows screen printed polymer binder and CNT ink.

FIG. 5 shows photolithography binder and CNT ink.

FIG. 6 shows CNT printed coating method.

FIG. 7 is a one part ink printed by conventional processes.

FIG. 8 is a one part dye applied to a bibulous fiber

FIG. 9 is a SEM showing the surface roughness of a sample made from the dispersions of the invention

### DESCRIPTION OF THE INVENTION

The preferred embodiments of the present invention and its advantages are understood by referring to the Figures.

The invention relates to particular electrically conductive inks, dyes and coatings formed from a dispersion comprised of carbon nanotubes and methods of forming the same. The conductive inks, dyes and coatings comprised of carbon nanotubes demonstrate the advantages of light transmission and smooth surface morphologies because of the low solids concentrations over those materials comprising carbon nanotubes disclosed in the prior art. The invention selectively uses dispersions in the formulation of inks and dyes formed from carbon nanotubes with a particular diameter less than 20 nm. The resulting conductive inks and coatings provide excellent conductivity and translucent qualities and smooth surface morphologies when applied to a substrate and cured over those conductive inks, dyes and coatings disclosed in the prior art. The improved surface morphologies of dispersions of the invention form conductive inks and coatings with surface morphology roughness less than 100 nano meters when compared to the surface roughness of the base substrate which is significantly smoother than current printed ink technologies which are designed as dispersions of finely divided graphite, silver or silver chloride particles in a thermoplastic resin and contain solids in the range of 20% to 60%. These particles tend to be at least 100 microns to 10 microns in diameter and result in a surface roughness in the 1-2 micron range. The carbon nanotube conductive inks formed from dispersions of the invention and having of the same conductive capacity have solids contents of 2-3% and the particle size is less than 20 nanometers. Compared to conventional inks, this is 500 times smaller than the 10 micron particle, the surface roughness is 28 times smoother and the solid content is between 6 and 20 times less.

In relation to the above, it has been found that nanotubes with an outer diameter of less than 20 nanometers and more preferably less than 10 nm are particularly good candidates to impart conductivity, smooth surface morphology and translucent qualities at low loading doses of carbon nanotubes to total weight. These carbon nanotubes have been shown to exhibit electrical conductivity as high as copper, strength 100 times greater than steel at one sixth the weight, and high strain to failure ratios. However, there has been no report of using larger multi wall and single wall carbon nanotubes in an electrically conductive and translucent ink, dyes or coating that provides high conductivity, wet on demand processing and smooth surface morphologies with a low solids concentration after being applied to a substrate. To achieve translucent ink that will result in a smooth surface morphology and conductivity requires specific formulations, applications and specific processing of the materials.

Carbon nanotubes are known and have a conventional meaning. Various descriptions can be found in the literature including in the following references (R. Saito, G. Dresselhaus, M. S. Dresselhaus, “Physical Properties of Carbon Nanotubes,” Imperial College Press, London U.K. 1998, or A. Zettl “Non-Carbon Nanotubes” Advanced Materials, 8, p. 443 (1996)). The carbon nanotubes described in this literature can be applied by methods of the present invention to form conductive inks and coatings that exhibit both high conductivity, smooth surface morphology and good translucent properties.

In a preferred embodiment, carbon nanotubes of this invention are comprised of straight and bent multi-walled nanotubes (MWNTs), straight and bent double-walled nanotubes (DWNTs) and straight and bent single-walled nanotubes, and various compositions of these nanotube forms and common by-products contained in nanotube preparations such as described in U.S. Pat. No. 6,333,016, which is incorporated herein by reference in its entirety.

The nanotubes of the invention have an outer diameter of less than 20 nm and preferably less than 10 nm. In another preferred embodiment, nanotubes used in the present invention have an outer diameter of less than 3.25 nm. In another preferred embodiment, nanotubes of the invention have an outer diameter of less than 3.0 nm. In another preferred embodiment, the nanotubes have an outer diameter of about 0.5 to about 2.5 nm. In another preferred embodiment, the nanotubes have an outer diameter of about 0.5 to about 2.0 nm. In another preferred embodiment, the nanotubes have an outer diameter of about 0.5 to about 1.5 nm. In another preferred embodiment, the nanotubes have an outer diameter of about 0.5 to about 1.0 nm. The aspect ratio may be between 10 and 2000.

In a preferred embodiment, the nanotubes comprise single or multi walled carbon-based carbon nanotubes containing material. Carbon nanotubes can be formed by a number of techniques, such as laser ablation of a carbon target, decomposing a hydrocarbon, and setting up an arc between two graphite conductive inks and coatings. For example, U.S. Pat. No. 5,424,054 to Bethune et al. describes a process for producing single-walled carbon nanotubes by contacting carbon vapor with cobalt catalyst. The carbon vapor is produced by electric arc heating of solid carbon, which can be amorphous carbon, graphite, activated or decolorizing carbon or mixtures thereof. Other techniques of carbon heating are discussed, for instance laser heating, electron beam heating and RF induction heating. Smalley (Guo, T., Nikoleev, P., Thess, A., Colbert, D. T., and Smally, R. E., Chem. Phys. Lett. 243: 1-12 (1995)) describes a method of producing single-walled carbon nanotubes wherein graphite rods and a transition metal are simultaneously vaporized by a high-temperature laser. Smalley (Thess, A., Lee, R., Nikolaev, P., Dai, H., Petit, P., Robert, J., Xu, C., Lee, Y. H., Kim, S. G., Rinzler, A. G., Colbert, D. T., Scuseria, G. E., Tonarek, D., Fischer, J. E., and Smalley, R. E., Science, 273: 483-487 (1996)) also describes a process for production of single-walled carbon nanotubes in which a graphite rod containing a small amount of transition metal is laser vaporized in an oven at about 1200 degree. C. Single-wall nanotubes were reported to be produced in yields of more than 70%. U.S. Pat. No. 6,221,330, which is incorporated herein by reference in its entirety, discloses methods of producing single-walled carbon nanotubes that employ gaseous carbon feedstocks and unsupported catalysts.

Carbon nanotubes are very flexible and naturally aggregate to form ropes of tubes. The formation of carbon nanotubes ropes is used by the present invention in the conductive inks, dyes or coatings produced. The formation of the ropes allows the conductivity of the conductive inks and coatings formed by the means described herein to be very high, while loading of the carbon nanotubes is very low. The highly conductive inks, dyes and coatings formed from the dispersions have good translucent properties and have smooth surface morphologies after application to a substrate due to the low solids concentrations. In the rope formulation process, the material is applied and processed appropriately so as to achieve the correct orientation, which provides smooth surface morphologies, light transmission and conductivity. However, since the formation of ropes during the formulation process causes the loss of carbon nanotubes by forming unusable carbon nanotube masses, a means is needed to limit the loss during formulation but permit the forming of ropes after application on to the substrate. The formulation of the carbon nanotube coating limits the formation of ropes while the carbon nanotubes are in the wet dispersion phase. In the formulation, the carbon nanotubes are formed into dispersion with a carrier that is capable of dispersing the carbon nanotubes onto a substrate when applied. The formulation is preferably capable of being dried by evaporation so that the carbon nanotubes are left behind on the substrate and have formed the appropriate bonds after the curing process. The curing process of the invention provides a means to re-enable the process of rope formation. It consists of applying heat over time to the dispersion and substrate so that the carbon nanotubes laid down have the time to form a mat of ropes over the surface of the substrate. The curing process of the invention provides the mechanism that forms the carbon nanotubes into a conductive mat after wet application and allows for use of the significantly less expensive multi-walled carbon nanotubes.

The resulting conductive inks, dyes and coatings made from the dispersions of the invention provide excellent conductivity, smooth surface morphologies and translucent appearance at low loadings of nanotubes. In a preferred embodiment, the nanotubes are present in the dye, ink or coating at about 0.001 to about 3% based on weight. Preferably, the nanotubes are present in said conductive ink or coating at about 0.01 to about 0.1%, which results in a good conductivity, smooth surface morphologies and translucent appearance. When used in a dye formulation at about 0.01 to about 0.1% the result is a dye that has good conductivity and the carbon nanotubes do not affect the dye coloration. The conductivity is the result of the carbon nanotubes, when mixed with the dye base and the mixture applied to a bibulous or absorbent fiber, preferentially adhere to the outer diameter of the fiber forming a conductive mat around the fiber.

The conductive inks, dyes and coatings formed from dispersions of the invention are useful in a variety of applications that require a conductive and translucent coating with a smooth surface morphology such as ESD protection, EMI/RFI shielding, low observability, polymer electronics (e.g., translucent conductor layers for plastic chips, antennas, conductive encoding methods, etc.) and devices used in co-pending provisional applications U.S. 60/546,762 strip electrode with conductive nanotube printing and U.S. 60/652,111 Taser personnel armor and co-pending application Ser. No. 11/029,270 Security marking and security mark, the disclosures of which are incorporated herein by reference in their entirety. The surface resistance of the conductive inks and coatings can easily be adjusted to adapt the conductive inks and coatings to these applications that have different target ranges for electrical conductivity. For example, it is generally accepted that the resistance target range for ESD protection at 100,000-10,000,000 ohms/square is adequate. It is also generally accepted that a resistance for conductive coatings for EMI/RFI shielding should be <10,000 ohms/square. It is also generally accepted that low observability coatings for transparencies is typically <1000 ohms/square, preferably <100 ohms/square. For polymer electronics, and inherently conductive polymers (ICPs), the resistivity values typically are <10000 ohms/square. However, traditional inks made from carbon nanotubes can meet these conductivity requirements but the coatings have a rough and irregular surface morphology that reduces the commercial applicability of the inks. Devices made from the resulting conductive coatings would not be suitable for those applications requiring good translucent and smooth surface morphology properties such as devices used in co-pending provisional applications U.S. 60/546,762 strip electrode with conductive nanotube printing and U.S. 60/652,111 Taser personnel armor and co-pending application Ser. No. 11/029,270 Security marking and security mark, the disclosures of which are incorporated herein by reference in their entirety.

Accordingly, in a preferred embodiment, the conductive coating or ink has a surface resistance in the range of less than about 10,000 ohms/square. Preferably, the conductive ink or coating has a surface resistance in the range of about 10-10,000 ohms/square. Preferably, the conductive ink or coating has a surface resistance in the range of about 100-10,000 ohms/square. Preferably, the conductive coating or ink has a surface resistance in the range of less than about 1000 ohms/square. Preferably, the conductive ink or coating has a surface resistance in the range of less than about 100 ohms/square. Preferably, the conductive ink or coating has a surface resistance in the range of about 10-100 ohms/square.

The conductive inks and coatings also have volume resistances in the range of about 100 ohms-cm to about 10,000 ohms-cm. The volume resistances are as defined in ASTM D4496-87 and ASTM D257-99.

The conductive inks and coatings of the invention demonstrate excellent translucent properties and differentially smooth surface morphologies when compared to the base substrate. The conductive inks and coatings also have low solids concentrations. Improved surface morphologies are important because the diffraction of light is less with a smooth surface and therefore the translucent properties of the ink or coating are improved by creating a smoother surface morphology. Additionally when an ink of the present invention is used for devices used in co-pending provisional applications U.S. 60/546,762 strip electrode with conductive nanotube printing and U.S. 60/652,111 Taser personnel armor and co-pending application Ser. No. 11/029,270 Security marking and security mark, the improved surface morphology increases the wear ability of the coating, decreases electrochemical variation, and improves the translucent properties of the coating. These coatings provide very high conductive properties and exceptional smoothness with good physical properties. For example, the conductive ink or coating has a total transmittance of at least about 60% and provides a diffential surface morphology of 100 nm or less. The very smooth surface morphology is the result of the very low concentration of solids (carbon nanotubes) in the ink formulations that minimizes the increase in surface morphology by not requiring high concentrations of large particles.

In another preferred embodiment, the dispersions of carbon nanotubes are added to form conductive dyes. Such dyes may contain additional conductive, partially conductive or non-conductive materials. The presence of nanotubes induces conductive properties to the dyes, which is not normally possible with conventional dyes that do not contain nanotubes, and because of the translucent nature of the resulting carbon nanotube dispersion the carbon nanotubes do not impair the coloration properties of the dye. The carbon nanotubes, when mixed with the dye base and the mixture applied to a bibulous or absorbent fiber preferentially adhere to the outer diameter of the fiber forming a conductive mat around the fiber. Dyes formed from this process may be in any form such as a solid or liquid, and is preferably a powder, a coating, an emulsion, or mixed dispersion.

In a preferred embodiment, the conductive ink Or coating has a total light transmittance of about 60% or more. In another preferred embodiment, the conductive ink and coating has a total light transmittance of about 80% or more. In another preferred embodiment, the conductive ink and coating has a differential surface morphology compared to the base substrate of about 100 nm or less. In another preferred embodiment, the conductive ink and coating has a differential surface morphology compared to the base substrate of about 50 nm or less.

The conductive inks and coatings range from moderately thick to very thin. For example, the conductive inks and coatings can have a thickness between about 0.5 nm to about 1000 microns. In a preferred embodiment, the conductive inks and coatings can have a thickness between about 0.5 nm to about 1000 microns. In another preferred embodiment, the conductive inks and coatings have a thickness between about 0.5 nm to about 500 microns. In another preferred embodiment, the conductive inks and coatings have a thickness between about 0.05 nm to about 500 microns. In another preferred embodiment, the conductive inks and coatings have a thickness between about 0.05 nm to about 400 microns. In another preferred embodiment, the conductive inks and coatings have a thickness between about 1.0 nm to about 300 microns. In another preferred embodiment, the conductive inks and coatings have a thickness between about 1.0 nm to about 200 microns. In another preferred embodiment, the conductive inks and coatings have a thickness between about 1.0 nm to about 100 microns. In another preferred embodiment, the conductive inks and coatings have a thickness between about 1.0 nm to about 50 microns.

In another preferred embodiment, the conductive coating, conductive ink and coating or ink further comprises a polymeric material. The polymeric material may be selected from a wide range of natural or synthetic polymeric resins. The particular polymer may be chosen in accordance with the strength, structure, or design needs of a desired application. In a preferred embodiment, the polymeric material comprises a material selected from the group consisting of thermoplastics, thermosetting polymers, elastomers and combinations thereof. In another preferred embodiment, the polymeric material comprises a material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof. In another preferred embodiment, the polymeric material comprises a material selected from the group consisting of ceramic hybrid polymers, phosphine oxides and chalcogenides.

In another preferred embodiment, the conductive coating, conductive ink and coating or ink formulation comprises a solvent, surfactant and dispersing agent. The solvent can be selected from ethanol, methanol, isopropanol, acetonitrile, hexane, heptane, acetone, water, ethers, and alcohols. Additionally the dispersing agent or surfactant is selected from materials that assist in the suspension of the carbon nanotubes and other solids in the dispersion but do not hinder the conductivity after curing. These dispersing agents or surfactants include, but are not limited to, sorbitan, fatty acid esters of sorbitan (e.g., sorbitan monolaurate, DISPERSE-AYD-DA W-72, and the like), celluloses (e.g., microcrystalline cellulose such as AVICEL RC-591 (available from FMC Corp.), microcrystalline hydroxyethylcellulose such as NATROSOL-250 M (available from Aqualon) and the like), non-ionic detergent ethers (e.g., TRITON X-100 (available from Sigma-Aldrich, Inc.) and the like), and ethylene oxides bearing synthetic surfactants, wetting agents, detergents, emulsifiers, combinations of the foregoing, as well as combinations of any of the foregoing dispersing agents or surfactants.

Conductive inks and coatings of this invention may be easily formed and applied to a substrate such as a dispersion of nanotubes alone in solvents such as acetone, water, ethers, and alcohols. The solvent is then removed by normal processes such as drying or heating to form the desired conductive ink and coating of nanotubes. The conductive inks and coatings may be applied by other known processes such as spray painting, dip coating, spin coating, knife coating, kiss coating, gravure coating, screen printing, stenciling, ink jet printing, pad printing, other types of printing or roll coating. However, curing temperature and curing time affect the formation of a conductive mat of interwoven carbon nanotubes. When mixed with a traditional dye system the substrate is usually dipped or spray coated.

A dispersion is defined as a composition comprising preferably, but not limited to, a uniform or non-uniform distribution of two or more heterogeneous materials. Those materials may or may not chemically interact with each other or other components of the dispersion or may be totally or partially inert to components of the dispersion. Heterogeneity may be reflected in the chemical composition, or in the form or size of the materials of the dispersion.

Most preferably the dispersion is formed by selectively isolating the carbon nanotubes by diameter. The diameter of the carbon nanotubes has a direct relationship to the resulting translucence of the conductive ink and coating formed by the dispersion. The dispersion is most preferably formed by carbon nanotubes that are smaller in diameter than 20 nm. The dispersion can be formed from the following process. A mixture of carbon nanotubes is formed by adding 1% by weight of carbon nanotubes selected from a group where the average diameter is less than 20 nanometers and more preferably less than 10 nm, 0.05 grams and then adding a 50% mixture of dehydrated alcohol (Ethanol undenatured) CAS 64-17-5 and water to achieve a 100 percent weigh mixture (0.95 grams). Then 0.001 gram of the dispersant Disperse-Ayd-DA W-72, from Elements Specialties, Hightstown, N.J. CAS 7732-18-5 is added to the mixture. The dispersant Disperse-Ayd-DA W-72 assists in dispersing the carbon nanotubes in the mixture and limits the formation of ropes while the carbon nanotubes are in the mixture. By limiting the formation of ropes or clumps the resulting mixture will be clearer. The mixture is ultrasonically mixed using a Branson Model 1510 ultrasonic bath for 25 minutes and then placed in a centrifuge for 10 minutes at 6500 rpm to selectively isolate the larger segments of the carbon nanotube population in the mixture. Alternatively the mixture can be allowed to settle out after ultrasonically mixing to selectively isolate the large segments or ropes of the carbon nanotubes. The mixture containing the refined carbon nanotube mixture is decanted from the centrifuged or settled mixture and contains a dispersed mixture of carbon nanotubes, dehydrated alcohol and water. The resulting mixture can be repeatedly centrifuged or allowed to settle for a longer time until the desired refinement is achieved. In a preferred embodiment, a wet dispersion that is dispersed in a coating or ink comprises a plurality of nanotubes with an outer diameter of less than 20 nm, the carbon nanotubes consisting of less than 10 percent by weight of the wet dispersion which is applied to a substrate as a wet dispersion and cured at a temperature of at least 75 degrees C. for a minimum of 10 minutes so that the resulting cured coating or ink is conductive and has a surface morphology of less than about 100 nm when compared to the base surface morphology.

An alternative formulation includes a mixture of carbon nanotubes formed by adding 1% by weight of carbon nanotubes selected from a group where the average diameter is less than 20 nanometers and more preferably less than 10 nm, 0.05 grams, and then adding a 50% mixture of dehydrated alcohol (Ethanol undenatured) CAS 64-17-5 and Acetonitrile (Sigma Aldrich catalog number 60004) to achieve a 100 percent weigh mixture (0.95 grams). Then 0.001 gram of the Nonionic surfactant Sorbitan monolaurate is added to the mixture. An excellent discussion on surfactants can be found in Surfactants: Fundamentals and Applications in the Petroleum Industry by Laurier L. Schramm of the Petroleum Recovery Institute ISBN 0 521 64067 9. The Sorbitan monolaurate assists in dispersing the carbon nanotubes in the mixture and limits the formation of ropes while the carbon nanotubes are in the mixture. The mixture is ultrasonically mixed using a Branson Model 1510 ultrasonic bath for 25 minutes and then placed in a centrifuge for 10 minutes at 6500 rpm or allowed to settle out to selectively isolate the larger segments of the carbon nanotube population in the mixture. The mixture containing the refined carbon nanotube mixture is decanted from the centrifuged mixture and contains a dispersed mixture of carbon nanotubes, dehydrated alcohol and Acetonitrile.

The refinement process allows for the creation of a translucent conductive ink and coating that provides a smooth surface morphology when properly cured.

The dispersion can also be formed from various flocculation methods to refine the carbon nanotubes mixture. Flocculation is the agglomeration of destabilized particles into microfloc and after into bulky floccules, which can be settled out and is called floc. The addition of another reagent called flocculant or a flocculant aid promotes the formation of the floc. The factors, which can promote the coagulation-flocculation, are the velocity gradient, the time, and the pH. The time and the velocity gradient increase the probability of the particles coming together. One way to refine the carbon nanotube mix is by heating the mixture to 70 degrees C. The carbon nanotubes flocculate to the bottom of the container when subjected to centrifuging. Also the carbon nanotubes can be induced to flocculate with the addition NaCl concentrations or nano size metals such as platinum. The nano size platinum material can be obtained from Sigma-Aldrich, item 483966, which is platinum nanosize activated powder, that can be added to the dispersion to achieve a percent weight of between 0.5% and 10%. Similar results can be achieved by adding a variety of nano size metals such as iron, copper, gold or silver. Additionally, MgCl₂ can be added to the dispersion and this will increase the flocculation and refinement of the carbon nanotubes.

Another method of creating a carbon nanotube dispersion is to create a dispersion of carbon nanotubes in 1% by weight aqueous sodium dodecyl sulfate (SDS) solution. The 1% by weight aqueous sodium dodecyl sulfate (SDS) solution is formulated. Then multi walled or single wall carbon nanotubes less than 20 nanometers in diameter are added to the solution so that they make up between 1 to 10% by weight of the carbon nanotube and SDS solution. Then the solution is homogenized for 1 hour at 6500 rpm, sonicated for 10 min, and centrifuged for 4 hours at 30000 rpm. The resulting solution is decanted to separate the carbon nanotubes in solution from those selectively isolated by the centrifuging. This method is detailed in Solution Casting and Transfer Printing Single-Walled Carbon Nanotube Films by Matthew A. Meitl et al. published by 2004 American Chemical Society on Web Jul. 29, 2004.

Finally the dispersion is added to a polymer binder, which can be selected from polymeric material comprising a material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof and thoroughly dispersed throughout the carbon nanotube composition to form a uniform dispersion. The polymer binder is added such that the carbon nanotube mixture is a maximum 10% by weight of the total dispersion. The mixture is sonically mixed to insure a thorough mixture. Then the final dispersant is applied onto a non conductive substrate by any applicable coating or printing technology. Once applied the mixture is cured by drying. It has been found that drying for a minimum of 20 minutes at 95 degrees C. is adequate, however the permissible variation is 10 to 25 minutes and 75-105 degrees C. During the curing time the refined carbon nanotubes in the mixture reorient and form ropes that are highly conductive. The curing process is important to the application of the dispersion and the creation of a conductive ink or coating. It is hypothesized that during the curing process the carbon nanotubes link together and form the conductive layer. When the mixture is not cured properly such as when it is air dried, the dispersion is not conductive and the hypothesis is that the polymer envelopes the carbon nanotubes so as to minimize the ability for the carbon nanotubes to string together. This property can be used in a beneficial manner by selectively curing the dispersion once it is applied to create patterned zones of conductive and non conductive areas.

The conductive inks, dyes and coatings formed from the final dispersion may be in a number and variety of different forms including, but not limited to, a solid conductive ink, dye and coating, a partial conductive ink and coating, a foam, a gel, a semi-solid, a powder, or a fluid. Conductive inks, dyes and coatings may exist as one or more layers of materials of any thickness and three-dimensional size. They can also be added to traditional dye compounds and used to dye materials such as cloth and polymer films so that they are conductive.

The substrate is not critical and can be any conductive or non-conductive material, for example, metals, cloth, organic polymers, inorganic polymers, polyester conductive ink and coatings, crystals, etc. The substrate for example, may be transparent, semi-transparent, non transparent or opaque. For example, the substrate may be a woven carbon or polyester material or coated fabric (resin coated fabric) wherein the conductive inks and coatings enhance conductive properties of the material. Alternatively, the substrate may be an electronic enclosure with a conductive ink and coating to render the surface conductive with a differential surface morphology of 100 nm or less compared to the base substrate without significantly changing the appearance of the enclosure.

The conductive inks, dyes and coatings comprising dispersions of carbon nanotubes in a proper amount mixed with a polymer can be easily synthesized. At most a few routine parametric variation tests may be required to optimize amounts for a desired purpose. Appropriate processing control for achieving a desired array of nanotubes with respect to the plastic material can be achieved using conventional mixing and processing methodologies, including but not limited to, conventional extrusion, multi-dye extrusion, press lamination, etc. methods or other techniques applicable to incorporation of nanotubes into a polymer. However, the preferred embodiment uses a spray coating method of applying the nanotube based dispersion to the non conductive substrate.

The nanotubes may be dispersed substantially homogeneously throughout the polymeric dispersion material but can also be present in gradient fashion, increasing or decreasing in amount (e.g. concentration) from the external surface toward the middle of the material or from one surface to another, etc. Alternatively, the nanotubes can be dispersed as an external skin or internal layer thus forming interlaminate structures.

In a preferred embodiment, the nanotube conductive ink and coatings can themselves be over-coated with a polymeric material. In this way, the invention contemplates, in a preferred embodiment, novel laminates or multi-layered structures comprising conductive inks and coatings of nanotubes over coated with another coating of an inorganic or organic polymeric material. These laminates can be easily formed based on the foregoing procedures and are highly effective for distributing or transporting electrical charge. The layers, for example, may be conductive, such as tin-indium mixed oxide (ITO), antimony-tin mixed oxide (ATO), fluorine-doped tin oxide (FTO), aluminum-doped zinc oxide (FZO) layer, or provide UV absorbance, such as a zinc oxide (ZnO) layer, or a doped oxide layer, or a hard coat such as a silicon coat. Additionally the polymer material can be selected from a material selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, polynucleotides and mixtures thereof. In this way, each layer may provide separate desirable characteristics such as wear resistance or patterning.

In a preferred embodiment, the multi-layered structures have alternating layers of nanotube-containing and non-nanotube containing layers that are formed to provide circuits formed from conductive inks and coatings which are patterned to meet the requirements of a specific embodiment and have a differential surface morphology compared to the base substrate of less than 100 nm. These embodiments are described in co-pending provisional applications U.S. 60/546,762 strip electrode with conductive nanotube printing and U.S. 60/652,111 Taser personnel armor and co-pending application Ser. No. 11/029,270 Security marking and security mark, the disclosures of which are all incorporated herein by reference.

In an alternative embodiment the dispersion is formed by selectively isolating the carbon nanotubes by diameter. The diameter of the carbon nanotubes has a direct relationship to the resulting translucence or translucent properties of the conductive ink and coating formed by the dispersion. The dispersion is most preferably formed by carbon nanotubes that are smaller in diameter than 20 nm. The dispersion can be formed from the following process. A mixture of carbon nanotubes is formed by adding 1% by weight of carbon nanotubes selected from a group where the average diameter is less than 20 nanometers and more preferably less than 20 nm, 0.05 grams and then adding a 50% mixture of dehydrated alcohol (Ethanol undenatured) CAS 64-17-5 and water mix to achieve a 100 percent weigh mixture (0.95 grams). Then 0.001 gram of the dispersant Disperse-Ayd-DA W-72, (Elements Specialties, Hightstown, N.J. CAS 7732-18-5) is added to the mixture. The dispersant Disperse-Ayd-DA W-72 assists in dispersing the carbon nanotubes in the mixture and limits the formation of ropes while the carbon nanotubes are in the mixture. By limiting the formation of ropes or clumps in the mixture, the resulting mixture will be clearer. The mixture is ultrasonically mixed using a Branson Model 1510 ultrasonic bath for 25 minutes and then placed in a centrifuge for 10 minutes at 6500 rpm to selectively isolate the larger segments of the carbon nanotube population in the mixture. The mixture can alternatively be allowed to settle, thereby allowing the formation of clumps that form on the bottom. The resulting mixture containing the refined carbon nanotube mixture is decanted from the centrifuged mixture and contains a dispersed mixture of carbon nanotubes, dehydrated alcohol and water. The resulting mixture can be repeatedly centrifuged or allowed to settle for longer duration until the desired refinement is achieved.

An alternative formulation includes a mixture of carbon nanotubes that is formed by adding 1% by weight of carbon nanotubes selected from a group where the average diameter is less than 20 nanometers and more preferably less than 10 nm, 0.05 grams and then adding a 50% mixture of dehydrated alcohol (Ethanol undenatured) CAS 64-17-5 and Acetonitrile (Sigma Aldrich catalog number 60004) to achieve a 100 percent weigh mixture (0.95 grams). Then 0.001 gram of the nonionic surfactant Sorbitan monolaurate is added to the mixture. An excellent discussion on surfactants can be found in Surfactants: Fundamentals and Applications in the Petroleum Industry by Laurier L. Schramm of the Petroleum Recovery Institute ISBN 0 521 64067 9. The Sorbitan monolaurate assists in dispersing the carbon nanotubes in the mixture and limits the formation of ropes while the carbon nanotubes are in the mixture. The mixture is ultrasonically mixed using a Branson Model 1510 ultrasonic bath for 25 minutes and then placed in a centrifuge for 10 minutes at 6500 rpm or allowed to settle out to selectively isolate the larger segments of the carbon nanotube population in the mixture. The mixture containing the refined carbon nanotube mixture is decanted from the centrifuged or settled mixture and contains a dispersed mixture of carbon nanotubes, dehydrated alcohol and Acetonitrile.

The dispersion can also be formed from various flocculation methods to refine the carbon nanotubes mixture.

Another method of creating a carbon nanotube dispersion is to create a dispersion of carbon nanotubes in 1% by weight aqueous sodium dodecyl sulfate (SDS) solution. The 1% by weight aqueous sodium dodecyl sulfate (SDS) solution is formulated: then multi walled or single wall carbon nanotubes less than 20 nanometers in diameter are added to the solution so that they make up between 1 to 10% by weight of the carbon nanotube and SDS solution. Then the solution is homogenized for 1 hour at 6500 rpm, sonicated for 10 min, and centrifuged for 4 hours at 30000 rpm. The resulting solution is decanted to separate the carbon nanotubes in solution from those selectively isolated by the centrifuging. This method is detailed in Solution Casting and Transfer Printing Single-Walled Carbon Nanotube Films by Matthew A. Meitl et al. published by 2004 American Chemical Society on Web Jul. 29, 2004.

The first step in forming the multi-layered smooth conductive ink and coating is to coat the refined carbon nanotubes dispersion onto a non conductive substrate by any applicable coating technology. Spray coating is one way that allows the quantity of carbon nanotubes mixture to be applied uniformly to the substrate. Once applied the mixture is cured by drying. It has been found that drying for 20 minutes at 95 degrees C. is adequate, however the permissible variation is 10 to 25 minutes and 75-105 degrees C. During the curing time the refined carbon nanotubes in the dispersion reorient and form ropes that are highly conductive. These ropes constructs are highly conductive, but fragile and can easily be damaged by mechanical means. Additional spray coatings, followed by curing of each subsequent layer can be added onto the initial layer to increase the conductivity of the conductive carbon nanotubes mat. After the desired number of carbon nanotubes layers have been applied and properly cured, they need to be protected. The process forms a fragile conductive ink and coating formed from the carbon nanotubes. To protect the carbon nanotubes a polymer or conductive coating layer is overlaid onto the carbon nanotube layer. A material which forms a conductive top layer such as Acheson Electrodag—PF 427, which is a polymer ink with Antimony Tin Oxide (ATO) as the conductive pigment can be applied to the carbon nanotube conductive ink and coating. The Acheson Electrodag—PF 427 has a low solids content and a high resistance level but protects the more conductive layer of carbon nanotubes when the bi-layer structure is cured appropriately. Alternatively a protective polymer coating can also be selected from polymeric materials selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof. The polymer coating or the Acheson Electrodag—PF 427 then cures at the same temperature and time as the carbon nanotubes layers until the composite is dried which is a minimum of 20 minutes at 95 degrees C. The curing process creates a composite conductive ink and coating. It is hypothesized that during the first curing process the carbon nanotubes link together and form the conductive layer. Further, during the second curing process the carbon nanotubes form links to the conductive materials in the conductive coatings or form links perpendicular to the plane of the substrate for the non conductive coatings, thereby creating a conductive ink and coating. When the dispersion is not cured properly the resulting layer is not conductive and it is hypothesis that the polymer envelopes the carbon nanotubes so as to minimize the ability for the carbon nanotubes to string together. This property can be used in a beneficial manner by selectively curing the dispersion once it is applied to create patterned zones of conductive and non conductive areas such as required with electrodes or antenna leads.

In another preferred embodiment of the invention, the dispersions of carbon nanotubes are added to traditional dyes forming conductive dyes. Such dyes may contain additional conductive, partially conductive or non-conductive materials. The presence of nanotubes induces conductive properties to the dyes, which are not normally possible with conventional dyes that do not contain nanotubes. Due to the translucence of the resulting carbon nanotube dispersion the carbon nanotubes do not impair the coloration properties of the dye. The carbon nanotubes, when mixed with the dye base and the mixture applied to a bibulous or absorbent fiber, preferentially adhere to the outer diameter of the fiber forming a conductive mat around the fiber. Dyes formed from this process may be in any form such as a solid or liquid, but is preferably a powder, a coating, an emulsion, or mixed dispersion.

In another preferred embodiment, the nanotubes are oriented after curing by exposing the conductive inks and coatings to a shearing, stretching, or elongating step or the like, e.g., using conventional polymer processing methodology. Such shearing-type processing refers to the use of force to induce flow or shear into the coating, forcing a spacing, alignment, reorientation, disentangling etc. of the nanotubes from each other greater than that achieved for nanotubes simply formulated either by themselves or in a dispersion with polymeric materials. Such disentanglement etc. can be achieved by application of pressure more or less parallel to a surface of the composite, or by application of differential force to different surfaces thereof, e.g., by shearing treatment by pulling of an extruded plaque at a variable but controlled rate to control the amount of shear and elongation applied to the extruded plaque. Orientation results in superior properties of the coating or ink, e.g., enhanced electromagnetic (EM) shielding. A typical application resulting in a 0.0005 inch thick conductive ink and coating on a 0.001 inch think polyester when subjected to a 3 pounds per inch of width tensile force increased the conductivity of the coating over a non processed sample by 9%.

Orientation refers to the axial direction of the nanotubes. The tubes either can be randomly oriented, orthogonally oriented (nanotube arrays), or preferably, the nanotubes are oriented in the plane of the conductive ink and coating.

In a preferred embodiment, the invention contemplates a plurality of differentially-oriented nanotube conductive ink and coating layers wherein each layer can be oriented and adjusted, thus forming filters or polarizers. These embodiments can be used in co-pending provisional applications U.S. 60/546,762 strip electrode with conductive nanotube printing and U.S. 60/652,111 Taser personnel armor and co-pending application Ser. No. 11/029,270 Security marking and security mark, which are all incorporated herein by reference in their entireties.

In an alternative embodiment, the invention also provides dispersions comprising nanotubes. Preferably, the nanotubes have an outer diameter less than 20 nm. The dispersions are suitable for forming conductive inks, dyes and coatings as described herein. Accordingly, the dispersions may optionally further comprise a polymeric material as described herein. The dispersions may optionally further comprise an agent such as a plasticizer, softening agent, filler, reinforcing agent, processing aid, stabilizer, antioxidant, dispersing agent, binder, a cross-linking agent, a coloring agent, a UV absorbent agent, or a charge adjusting agent.

Dispersions of the invention may further comprise additional conductive organic materials, inorganic materials or combinations or mixtures of such materials. The conductive organic materials may comprise particles containing buckeyballs, carbon black, fullerenes, and nanotubes with an outer diameter of less than about 20 nm, and combinations and mixtures thereof. Conductive inorganic materials may comprise particles of aluminum, antimony, beryllium, cadmium, chromium, cobalt, copper, doped metal oxides, iron, gold, lead, manganese, magnesium, mercury, metal oxides, nickel, platinum, silver, steel, titanium, zinc, or combinations or mixtures thereof. Preferred conductive materials include tin-indium mixed oxide, antimony-tin mixed oxide, fluorine-doped tin oxide, aluminum-doped zinc oxide and combinations and mixtures thereof. Preferred dispersions may also contain fluids, gelatins, ionic compounds, semiconductors, solids, surfactants, and combinations and mixtures thereof.

The curing process allows for the formation of a conductive layer with differentially smooth surface morphology when compared to the base material and it has been shown that the curing promotes the formation of the carbon nanotubes into conductive ropes. The coatings, dyes or inks formed from the aforementioned methods form conductive mats of ropes of carbon nanotubes that are both conductive and self-healing when cured properly. When a mechanical means, up to 0.005 inches of removal of material, is used to break the conductive ropes formed by the carbon nanotubes the conductivity is at first disrupted. After a period of time which testing has shown to be within 48 hours, the conductivity returns to the disrupted part even though the apparent removal of the coating is still evident. The carbon nanotubes have re-attached on the surface of the substrate to reform the conductive mat. However, the carbon nanotubes do not connect after curing when the carbon nanotubes are applied with a gap between traces and then cured. The separate traces when formed in this manner do not join together because they were not in communication when formed and cured with the other conductive carbon nanotubes in the separate trace. This phenomenon indicates that the mat or rope formation of carbon nanotubes has a memory of the configuration and that the carbon nanotubes that are formed during the curing process, even when theoretically encapsulated by the polymer, can reorient the bonds that have been disrupted. The curing process of 95 degrees C. and 20 minutes facilitates the processing of the carbon nanotubes into ropes. When the cure temperature is 30 degrees C. greater or 10 degrees less than the 75 degrees C. then the reformation process does not occur when disrupted by mechanical means. Also, if the curing time is less then 10 minutes the ropes will also not form properly and the reformation process does not occur when disrupted by mechanical means. All testing has indicated that appropriate curing allows for the suitable formation of the conductive carbon nanotubes mats or ropes. Without the proper curing temperature and duration the conductivity of the carbon nanotubes may be degraded or non existent.

The present invention, thus generally described, will be understood more readily by reference to the following examples, which are provided by way of illustration and are not intended to be limiting of the present invention.

### EXAMPLES

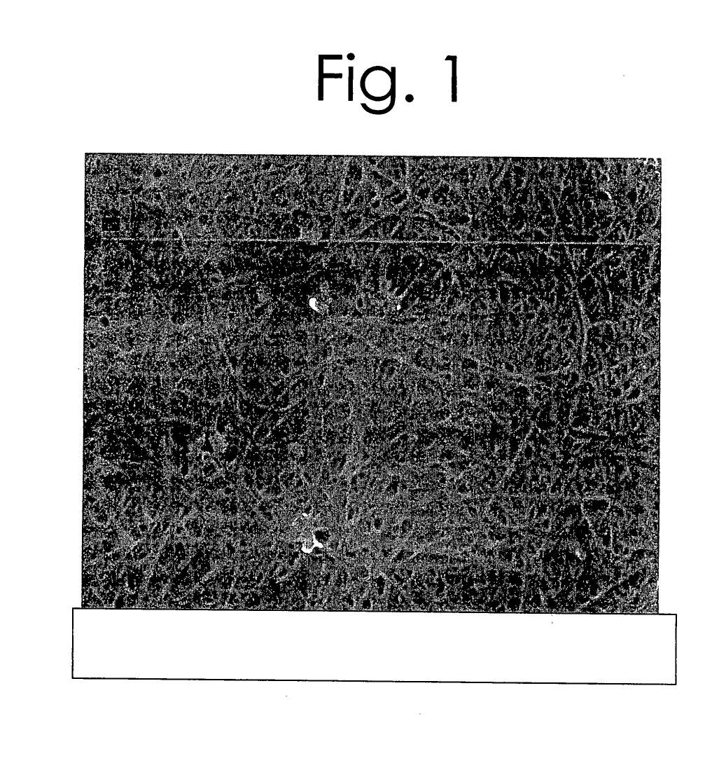

FIG. 1 is a picture of carbon nanotube mat formed by curing.

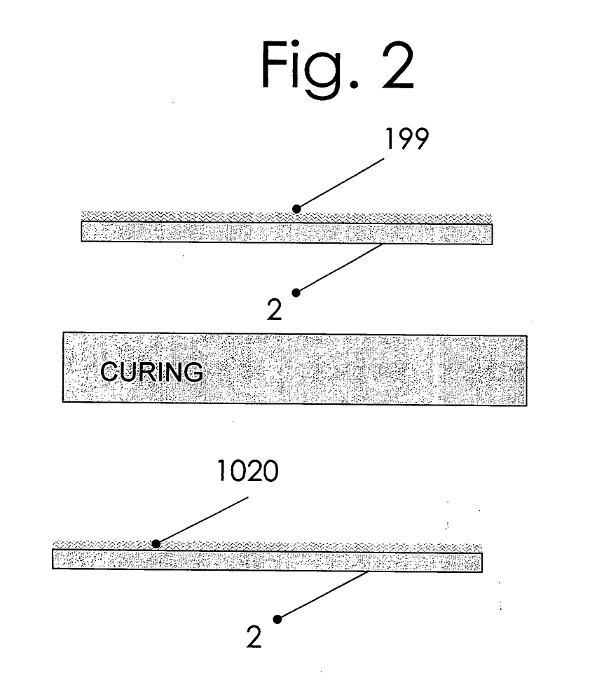

FIG. 2 shows CNT inks or dispersion coated on Polyester. The conductive inks and coatings are formed by coating the conductive ink (199) on a flexible film (2). The ink can be formed from single-walled or multi walled nanotubes and may be formed from multiple layers or dispersions containing, carbon nanotubes, polymers, carbon nanotubes/antimony tin oxide, carbon nanotubes/platinum, or carbon nanotubes/silver or carbon nanotubes/silver-chloride. This forms conductive material (1020) when cured properly.

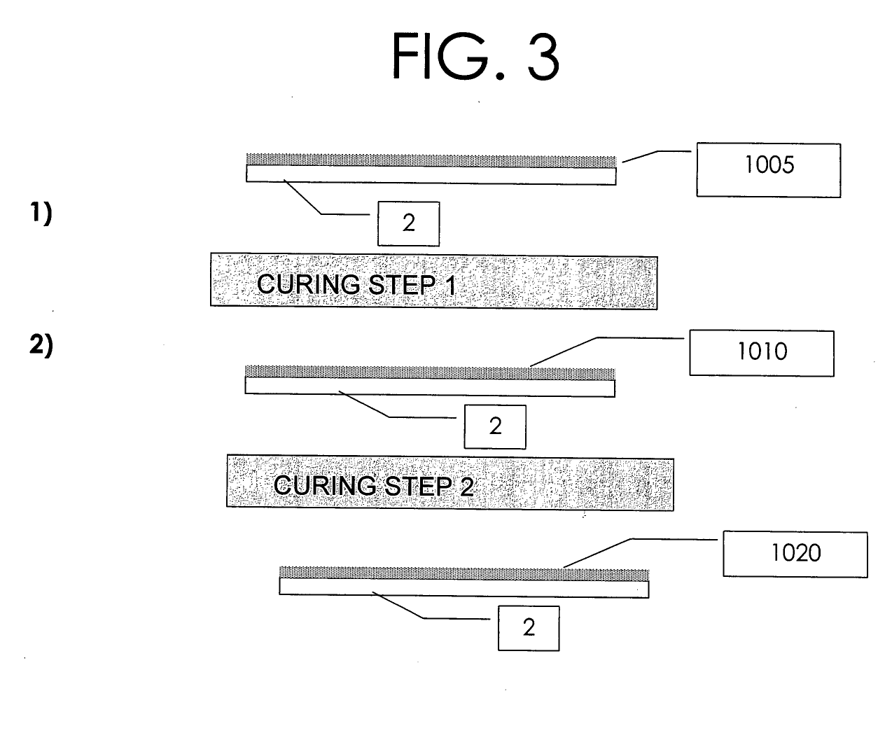

FIG. 3 shows a two part CNT ink or dispersion forming a conductive material of the invention. The coated carbon nanotubes layer 1005 is applied to the Polyester layer 2 and cured. The separate protective polymer coating 1010 is applied to cured carbon nanotube layer 1005 and Polyester (2) and then cured. The coated carbon nanotubes layer 1005 can be formed from one or more individual coating and curing steps. The polymer coating layer 1010 may be formed from conductive or non conductive materials, such as tin-indium mixed oxide (ITO), antimony-tin mixed oxide (ATO), fluorine-doped tin oxide (FTO), aluminum-doped zinc oxide (FZO) layer, or provide UV absorbance, such as a zinc oxide (ZnO) layer, or a doped oxide layer, or a hard coat such as a silicon coat. Additionally the polymer material can be selected from a material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof. After curing the layers the conductive coating 1020 is formed.

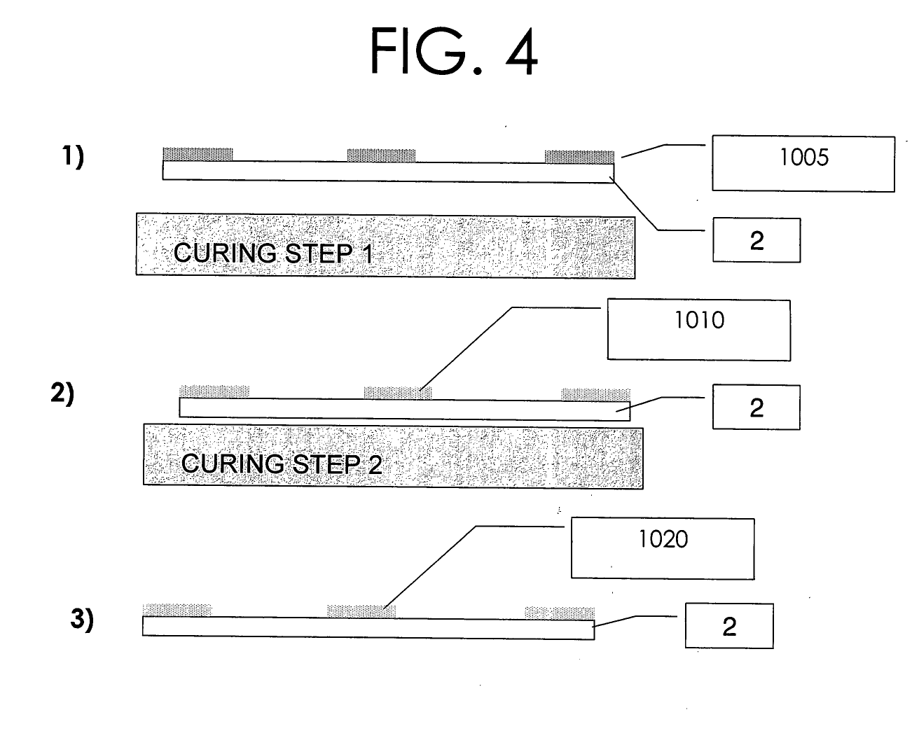

FIG. 4 shows a screen printed polymer binder method of application means for forming the conductive inks and coatings in FIG. 2. In this embodiment the conductive carbon nanotube ink (1005) is applied by screen printing or stenciling to the surface of the strip and then cured. The carbon nanotube ink layer 1005 can be applied in one or multiple steps with the applicable curing step applied to each sub layer of 1005. Curing can be done either for each layer or for the composite carbon nanotube conductive layer. The binder (1010) is then screen printed onto the carbon nanotube ink and the composite is cured forming the conductive inks and coatings. This forms conductive ink 1020.

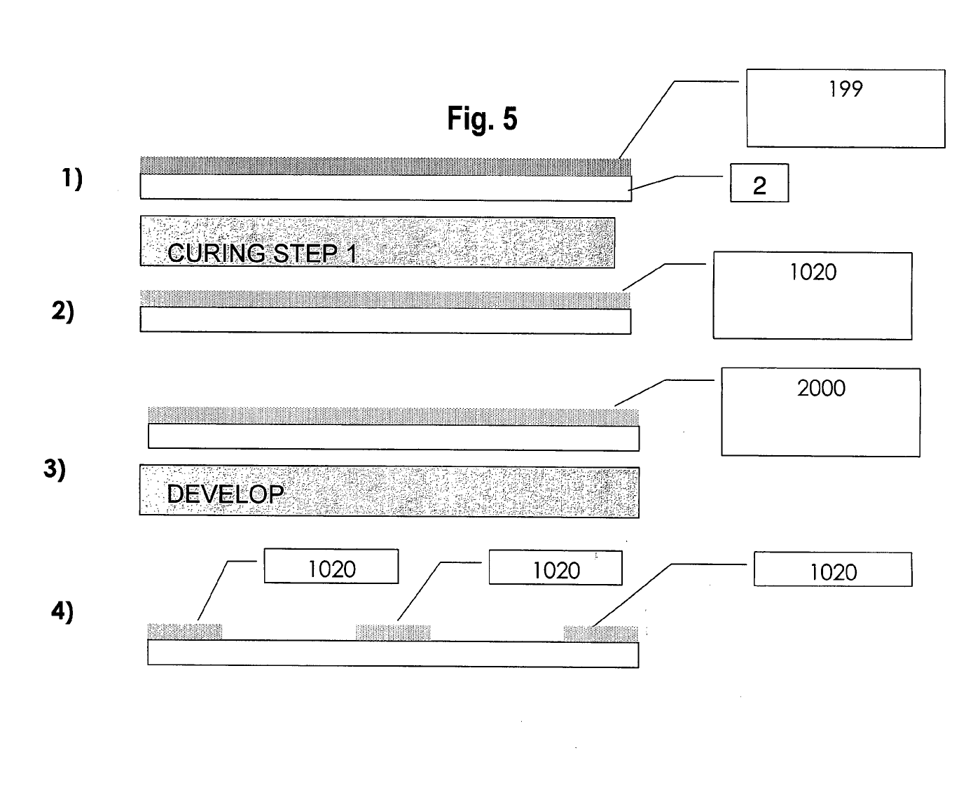

FIG. 5 a photolithography method of defining the conductive inks and coatings means for forming the conductive inks and coatings in FIG. 2. The coating (1005) is applied as described in FIG. 2: then a photolithography definable material (2000) is applied. The conductive areas (1) are exposed and developed to form the conductive inks and coatings (1020).

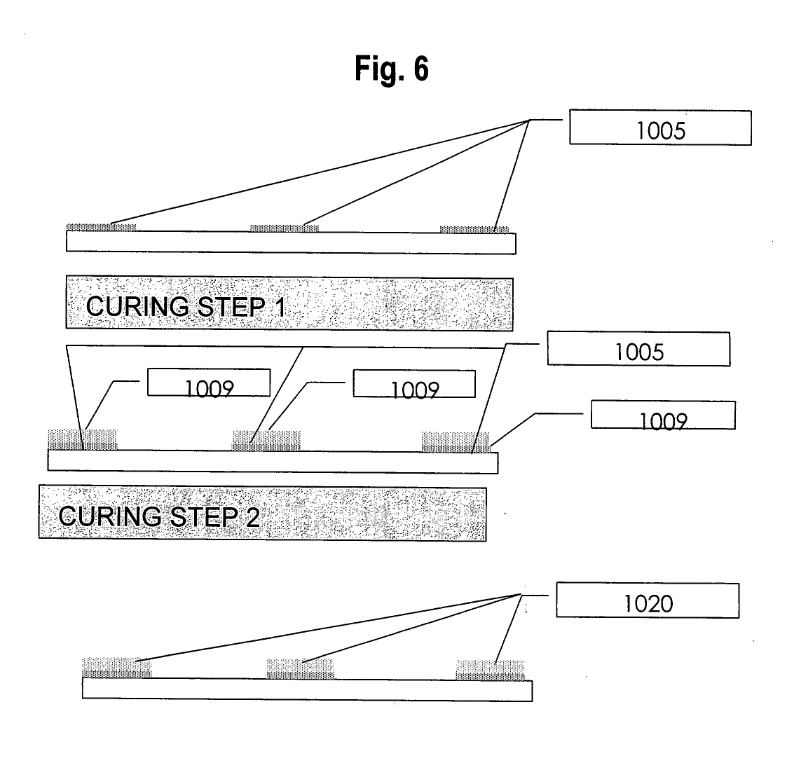

FIG. 6 shows a printed coating method for forming the conductive inks and coatings in FIG. 2 using a two part ink. The CNT ink (1005), which may be applied in one or more separate applications is printed on the flexible substrate 2 to define the conductive area and then cured. The polymer binder (1010) is then applied to the CNT coated areas, thus defining the conductive area (1020). The printing can be accomplished by screen printing, stenciling, ink jet printing, gravure, flexo, pad printing or other printing means.

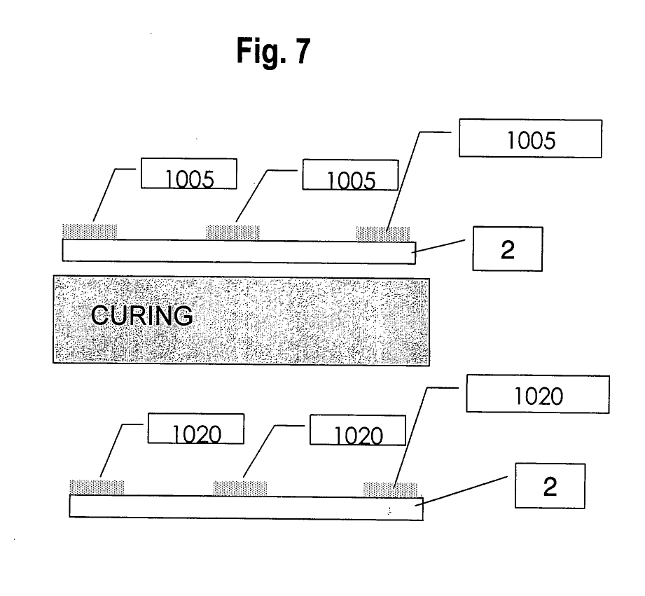

FIG. 7 is a one part ink (1005) printed conductive inks and coatings formed by conventional processes such as screen printing, stenciling, ink jet printing, gravure, flexo, pad printing or other printing means. The one part ink (1005) can be formed from single-walled or multi walled nanotubes and may be formed from multiple layers or dispersions containing, non conductive polymers, carbon nanotubes, carbon nanotubes/antimony tin oxide, carbon nanotubes/platinum, or carbon nanotubes/silver or carbon nanotubes/silver-chloride. The conductive inks and coatings (1020) are printed images resulting from the printing process after curing.

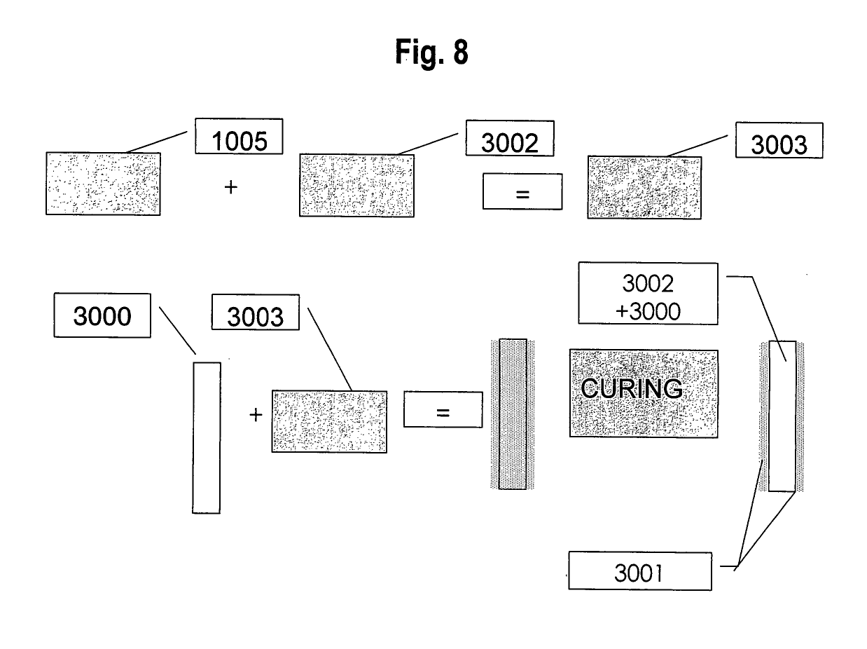

FIG. 8 is a one part or two part conductive dye (1005) applied to a bibulous fiber (3000) to form a conductive cloth used to dissipate energy or form conductive material such as used in co-pending application U.S. 60/652,111 Taser personnel armor which is included herein by reference. The carbon nanotubes are mixed with the dye base (3002) to form dye (3003) and then applied to a bibulous or absorbent fiber. The carbon nanotubes (3001) preferentially adhere to the outer diameter of the fiber (3000) forming a conductive mat around the fiber after curing and the dye base (3002) colors the fiber (3000).

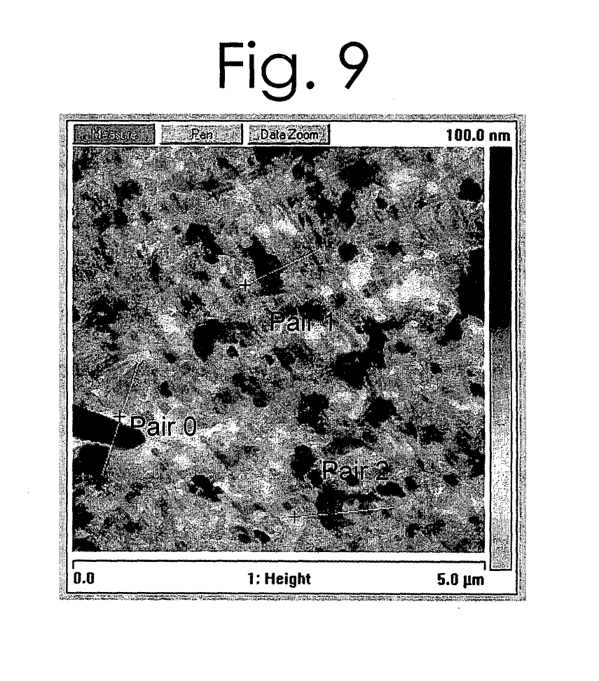

FIG. 9 shows an SEM of a coated piece of polyester coated first with a carbon nanotube dispersion containing 1% carbon nanotubes and over coated with Acheson Electrodag—PF 427. The smooth surface roughness is tabulated below:

| Selection | RMS in nm |
|---|---|
| Pair 0 | 21 nm |
| Pair 1 | 16 nm |
| Pair 2 | 17.5 nm |

The coatings, inks and dyes that are used in the above embodiments are most preferably formed by carbon nanotubes that are smaller in diameter than 20 nm. The coating can be formed from the following process. A dispersion of carbon nanotubes is formed by adding 1% by weight of carbon nanotubes, selected from a group where the average diameter is less than 20 nanometers and more preferably less than 10 nm, 0.05 grams, and then adding a 50% mixture of dehydrated alcohol (Ethanol undenatured) CAS 64-17-5 and water mix to achieve a 100 percent weigh mixture (0.95 grams). Then 0.001 gram of the dispersant Disperse-Ayd-DA W-72, (Elements Specialties, Hightstown, N.J. CAS 7732-18-5) is added to the mixture. The dispersant Disperse-Ayd-DA W-72 assists in dispersing the carbon nanotubes in the mixture and limits the formation of ropes while the carbon nanotubes are in the mixture. By limiting the formation of ropes or clumps the resulting mixture will be clearer. The mixture is ultrasonically mixed using a Branson Model 1510 ultrasonic bath for 25 minutes and then placed in a centrifuge for 10 minutes at 6500 rpm to selectively isolate the larger segments of the carbon nanotube population in the mixture. Alternatively the mixture can be allowed to settle to selectively isolate the larger segments of the carbon nanotube population in the mixture. The mixture containing the refined carbon nanotube mixture is decanted from the centrifuged or settled mixture and contains a dispersed mixture of carbon nanotubes, dehydrated alcohol and water. The resulting mixture can be repeatedly centrifuged or the settling time increased until the desired refinement is achieved. Alternative formulations include a mixture of carbon nanotubes formed by adding 1% by weight of carbon nanotubes selected from a group where the average diameter is less than 20 nanometers and more preferably less than 10 nm, 0.05 grams and then adding a 50% mixture of dehydrated alcohol (Ethanol undenatured) CAS 64-17-5 and Acetonitrile (Sigma Aldrich catalog number 60004) to achieve a 100 percent weigh mixture (0.95 grams). Then 0.001 gram of the nonionic surfactant Sorbitan monolaurate is added to the mixture. An excellent discussion on surfactants can be found in Surfactants: Fundamentals and Applications in the Petroleum Industry by Laurier L. Schramm of the Petroleum Recovery Institute ISBN 0 521 64067 9. The Sorbitan monolaurate assists in dispersing the carbon nanotubes in the mixture and limits the formation of ropes while the carbon nanotubes are in the mixture. The mixture is ultrasonically mixed and then placed in a centrifuge or allowed to settle to selectively isolate the larger segments of the carbon nanotube population in the mixture. The mixture containing the refined carbon nanotube mixture is decanted from the centrifuged or settled mixture and contains a dispersed mixture of carbon nanotubes, dehydrated alcohol and Acetonitrile.

The dispersion can also be formed from various flocculation methods to refine the carbon nanotubes mixture. Flocculation is the agglomeration of destabilized particles into micro floc and after into bulky floccules which can be settled, called floc. The addition of another reagent called flocculant or a flocculant aid promotes the formation of the floc. The factors, which can promote the coagulation-flocculation, are the velocity gradient, the time, and the pH. The time and the velocity gradient increase the probability of the particles coming together. One alternative way to refine the carbon nanotube mix is first heating the mixture to 70 degrees C. The carbon nanotubes flocculate to the bottom of the container when subjected to centrifuging or extended settling time. Also the carbon nanotubes can be induced to flocculate with the addition of NaCl concentrations or a nano size metal such as platinum. The nano size platinum material can be obtained from Sigma-Aldrich company item 483966, platinum nanosize activated powder, which can be added to the dispersion to achieve a percent weight of between 0.5% and 10%. Similar results can be achieved by adding a variety of nano size metals such as iron, copper, gold or silver. Additionally, MgCl₂ or NaCl can be added to the dispersion and this will increase the flocculation and refinement of the carbon nanotubes.

Another method of creating a carbon nanotube dispersion is to create a dispersion of carbon nanotubes in 1% by weight aqueous sodium dodecyl sulfate (SDS) solution. The 1% by weight aqueous sodium dodecyl sulfate (SDS) solution is formulated. Then multi walled or single wall carbon nanotubes less than 20 nanometers in diameter are added to the solution so that they make up between 1 to 10% by weight of the carbon nanotube and SDS solution. Then the solution is homogenized for 1 h at 6500 rpm, sonicated for 10 min, and centrifuged for 4 hours at 30000 rpm. The resulting solution is decanted to separate the carbon nanotubes in solution from those selectively isolated by the centrifuging. This method is detailed in Solution Casting and Transfer Printing Single-Walled Carbon Nanotube Films by Matthew A. Meitl et al. published by 2004 American Chemical Society on Web Jul. 29, 2004.

The two part conductive inks and coatings are formed by first coating the refined carbon nanotubes dispersion onto a non conductive substrate by any applicable coating technology. The preferred means of coating the carbon nanotube dispersion is to apply it with an air brush spraying device such as the single action airbrush #1401 from Air Brush City, Nampa, Ind., USA. However this first dispersion can be successfully applied with an ink jetting device. The ink jetting can be accomplished by using precision components from the Lee Company of Westbrook, Conn., such as the VHS-S/P 10+ Nanoliter Dispensing Valves. Once applied the mixture is cured by drying for 20 minutes at 95 degrees C., however the permissible variation is 10 to 25 minutes and 75-105 degrees C. During the curing time the refined carbon nanotubes in the dispersion reorient and form ropes that are highly conductive. Additional conductive layers can also be added followed by the appropriate curing time to form a layer that has increased conductivity. The curing process forms ropes or mats constructs between the multiple conductive layer applications. These ropes constructs formed during curing, while being highly conductive are fragile and can easily be damaged by mechanical means. To protect the fragile conductive ink, dye or coating formed from the carbon nanotubes, a conductive polymer coating such as Acheson Electrodag—PF 427, a polymer ink with Antimony Tin Oxide (ATO) as the conductive pigment is applied to the conductive inks and coatings. The Acheson Electrodag—PF 427 has a low solids content and a high resistance level but protects the more conductive layer of carbon nanotubes when the bi layer structure is cured appropriately. Other conductive mixtures of polymer and conductive or non conductive materials, such as tin-indium mixed oxide (ITO), antimony-tin mixed oxide (ATO), fluorine-doped tin oxide (FTO), or aluminum-doped zinc oxide (FZO) layer, or provide UV absorbance, such as a zinc oxide (ZnO) layer, or a doped oxide layer, or a hard coat such as a silicon coat may be used. The polymer material portion of the conductive mixture can be selected from a material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof.

Alternatively a non conductive polymer protective coating can be applied and may be selected from polymeric material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof.

Additionally, a one part dispersion can be formed by taking 0.1 grams mixture of the refined carbon nanotube mixture from above and adding 9.99 grams of either a conductive binder like the Acheson Electrodag—PF 427 or a binder selected from polymeric material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides and mixtures thereof, and thoroughly mixing the mixture. This produces a 1% dispersion which is conductive when cured properly by drying. During the curing time the refined carbon nanotubes in the mixture reorient and form ropes that are highly conductive. Additional conductive layers can also be added, followed by the appropriate curing time to form a layer that has increased conductivity. The curing form ropes or mats constructs between the multiple conductive layer applications. One part dispersions with a refined carbon nanotube component of the dispersion can be made where the refined component is as high as 10% of the weight of the final dispersion.

Alternatively the dispersions of carbon nanotubes are added to traditional dyes forming conductive dyes. Such dyes may contain additional conductive, partially conductive or non-conductive materials. The presence of nanotubes induces conductive properties to the dyes, which are not normally possible with conventional dyes that do not contain nanotubes. Due to of the translucence of the resulting carbon nanotube dispersion the carbon nanotubes do not impair the coloration properties of the dye. The carbon nanotubes, when mixed with the dye base and the mixture applied to a bibulous or absorbent fiber, preferentially adhere to the outer diameter of the fiber forming a conductive mat around the fiber. Dyes formed from this process may be in any form such as a solid or liquid, and are preferably a powder, a coating, an emulsion, or mixed dispersion. The dyes are applied by either dip coating or spray coating to imbibe the bibulous fibers of the cloth or material.

Conductive Coatings

Electrical conductivity is added to a coating is demonstrated. This data presented in this section was obtained using polyester, conductive inks and coatings formed from carbon nanotube dispersions described. Similar results to those presented below, have been collected on other coatings and are expected from most other conductive materials useful for forming coatings and inks.

Summary of Results

Successful incorporation of carbon nanotubes into conductive inks, dyes and coatings are listed here with a brief summary of some of the results obtained:

A) Electrical resistivity, concentration, and thickness of nanotube filled conductive inks and coatings. Resistivity easily adjusted from 100 to 100,000 ohms squared at any thickness greater than 1 micron. Resistivity through bulk or surface of conductive inks and coatings demonstrated with very high optical clarity and low haze.

B) Optical properties of carbon nanotube coated samples for polyester conductive ink and coating applications. Transmission loss of only 30-40% for 25 micron thick conductive inks and coatings with bulk conductivity. Transmission loss of only 15-20% for thinner 2-10 micron conductive inks and coatings.

C) Surface morphology was measured using an Optical Profilometer. The base polyester substrate surface roughness was measured using an Optical Profilometer and found to be 40 nm.

Each of these parameters is presented in detail following a brief discussion on the testing plan.

The coatings used for testing form two classes. The first class of coatings was made for comparative properties testing between conductive inks and coatings incorporating nanotubes dispersions applied in a two step process or as a single dispersion. In this matrix of samples, all preparation conditions, procedures, and materials where identical for the conductive inks and coatings made. Each sample had approximately a uniform final conductive inks and coatings thickness coating of approximately 0.0001 inches applied to the polyester. The loading concentration of carbon nanotubes was determined from preliminary test conductive inks and coatings created with carbon nanotube coatings with weight percentages between 0.03 to 0.30%. The ink thickness was selected to be 1 mil or less. The resulting sets of specimens were used in a test matrix comparing: A) electrical resistivity, B) optical transmittance and C) surface roughness. The preparation and results of testing the samples in this matrix are presented as listed above.

Preparation and Test Results for Samples

The first samples were made with a conductive polymer Acheson Electrodag—PF 427, which is a polymer ink with Antimony Tin Oxide (ATO) that has a low solids content and a high resistance level. A dispersion of carbon nanotubes is formed by adding 1% by weight of carbon nanotubes selected from a group where the average diameter is less than 20 nanometers, 0.05 grams and then adding a 50% mixture of dehydrated alcohol (Ethanol undenatured) CAS 64-17-5 and water mix to achieve a 100 percent weight mixture (0.95 grams). Then 0.001 gram of the dispersant Disperse-Ayd-DA W-72,(Elements Specialties, Hightstown, N.J. CAS 7732-18-5) is added to the mixture. The dispersant Disperse-Ayd-DA W-72 assists in dispersing the carbon nanotubes in the mixture and limits the formation of ropes while the carbon nanotubes are in the mixture. The mixture was ultrasonically mixed using a Branson Model 1510 ultrasonic bath for 25 minutes and then placed in a centrifuge for 10 minutes at 6500 rpm to selectively isolate the larger segments of the carbon nanotube population in the mixture. The dispersion containing the refined carbon nanotube mixture was decanted from the centrifuged mixture and contained a dispersed mixture of carbon nanotubes, dehydrated alcohol and water.

The carbon nanotube dispersion was sprayed onto 0.001 inch thick polyester panels that were first cleaned with soap and water and then rinsed in pure water and allowed to dry followed by a second cleaning with methanol and a lint free cloth and allowed to dry. The samples were cured for 20 minutes at 95 degrees C. The application of carbon nanotubes and the curing step was repeated 4 more times forming 5 applications of carbon nanotube dispersion. Then a conductive top layer was applied to protect the carbon nanotube layer. Acheson Electrodag—PF 427 which is a polymer ink with Antimony Tin Oxide (ATO) as the conductive pigment and a low solids content was applied to the carbon nanotube coated conductive inks and coatings using a screen printing process. The Acheson Electrodag—PF 427 was then cured at the same temperature and time as the carbon nanotube layers, which is a minimum of 20 minutes at 95 degrees C.

The second sample was made using a carbon nanotubes dispersion and a polymer coating top layer without a conductive oxide or metal dispersed into the polymer. A mixture of carbon nanotubes dispersion was formed by adding 1% by weight of carbon nanotubes selected from a group where the average diameter is less than 20 nanometers, 0.05 grams and then adding a 50% mixture of dehydrated alcohol (Ethanol undenatured) CAS 64-17-5 and water mix to achieve a 100 percent weight mixture (0.95 grams). Then 0.001 gram of the dispersant Disperse-Ayd-DA W-72, (Elements Specialties, Hightstown, N.J. CAS 7732-18-5) is added to the mixture. The dispersant Disperse-Ayd-DA W-72 assists in dispersing the carbon nanotubes in the mixture and limits the formation of ropes while the carbon nanotubes are in the mixture. The mixture is mixed using a Branson Model 1510 ultrasonic bath for 25 minutes and then placed in a centrifuge for 10 minutes at 6500 rpm to selectively isolate the larger segments of the carbon nanotube population in the mixture. The mixture containing the refined carbon nanotube mixture is decanted from the centrifuged mixture and contains a dispersed mixture of carbon nanotubes, dehydrated alcohol and water.

The carbon nanotube dispersion was sprayed onto 0.001 inch thick polyester panels that were first cleaned with soap and water and then rinsed in pure water and allowed to dry, followed by a second cleaning with methanol and a lint free cloth and allowed to dry. The samples were cured for 20 minutes at 95 degrees C. The application of carbon nanotubes and curing step was repeated 4 more times forming 5 applications of carbon nanotube dispersion. Then a polymer binder top layer was applied using a screen printing process and then cured to protect the carbon nanotube layer. The polymer binder used was polyurethane by Reichhold UROTUF 91634. The polyurethane was cured for 20 minutes at 95 degrees C. The final thickness of these samples were 1.1 mil final thickness.

The third sample was a dispersion of carbon nanotubes formed by adding 1% by weight of carbon nanotubes selected from a group where the average diameter is less than 20 nanometers and more preferably less than 10 nm, 0.05 grams and then adding a 50% mixture of dehydrated alcohol (Ethanol undenatured) CAS 64-17-5 and Acetonitrile (Sigma Aldrich catalog number 60004) to achieve a 100 percent weigh mixture (0.95 grams). Then 0.001 gram of the nonionic surfactant Sorbitan monolaurate is added to the mixture. The mixture was ultrasonically mixed using a Branson Model 1510 ultrasonic bath for 25 minutes and then placed in a centrifuge for 10 minutes at 6500 rpm to selectively isolate the larger segments of the carbon nanotube population in the mixture. The mixture containing the refined carbon nanotube mixture is decanted from the centrifuged mixture and contains a dispersed mixture of carbon nanotubes, dehydrated alcohol and Acetonitrile.

Then the dispersion was added to Acheson Electrodag—PF 427 which is a polymer, ink with Antimony Tin Oxide (ATO). The carbon nanotube mixture was added to the Acheson Electrodag—PF 427 so that the carbon nanotube mix comprised 1% by weight of the final mixture. After adding the two components the mixture was mixed for 20 minutes. Then the mixture was printed with a stenciled onto 0.001 inch thick polyester panels that were first cleaned with soap and water and then rinsed in pure water and allowed to dry followed by a second cleaning with methanol and a lint free cloth and allowed to dry. The conductive pigment and carbon nanotube mixture inks and coatings was then cured a minimum of 20 minutes at 95 degrees C.

The fourth sample was made using a carbon nanotubes dispersion and a dye mixture to dye a linen fabric. A dispersion of carbon nanotubes is formed by adding 1% by weight of carbon nanotubes selected from a group where the average diameter is less than 20 nanometers, 0.05 grams and then adding a 50% mixture of dehydrated alcohol (Ethanol undenatured) CAS 64-17-5 and water mix to achieve a 100% weight mixture (0.95 grams). Then 0.001 gram of the dispersant Disperse-Ayd-DA W-72, Elements Specialties, Hightstown, N.J. CAS 7732-18-5 is added to the mixture. The mixture is mixed using a Branson Model 1510 ultrasonic bath for 25 minutes and then placed in a centrifuge for 10 minutes at 6500 rpm to selectively isolate the larger segments of the carbon nanotube population in the mixture. The dispersion containing the refined carbon nanotube mixture was decanted from the centrifuged mixture and contains a dispersed mixture of carbon nanotubes, dehydrated alcohol and water.

The formulation of the indigo dye. The following ingredients were assembled:
10.5 g indigo powder
20.95 g washing soda
700 ml water
41.94 g sodium hydrosulfite.
   The procedure for the preparation of this dye is as follows. First step is dissolving the indigo powder into a small amount of warm water in order to form a paste. In another beaker the washing soda is dissolved in water. After that half of the washing soda is gradually added to the indigo powder paste and stirred thoroughly. After an even mixture is attained, half of the sodium hydrosulfite is added and stirred again. Finally enough warm water is added to have 700 ml of solution and then the solution is heated to 130° F. (around 54° C.). The carbon nanotube dispersion is then added to the dye mixture so that it forms 5% of the total volume. After the color of the solution begins to turn yellowish-green, wait for 20 minutes and the rest of the sodium hydrosulfite is spread over the dye, to render harmless any dissolved oxygen. During the preparation of the dye and during the dyeing procedure, stir very carefully in order to keep oxygen from being dissolved into the solution. For the actual dyeing process, we placed the linen material in the dye bath for 5 minutes and then remove it carefully. Right after the material is removed from the dye bath, it is yellow-greenish in color, but once exposed to the air it turns blue. Then allow the linen material to dry completely before rinsing with running water.

The linen panels are then cured to form the carbon nanotubes into a conductive mat that is integrated into the conductive dye formulation creating a conductive path in the linen panel formed by the dye. The samples were cured for 20 minutes at 95 degrees C. The carbon nanotubes, when mixed with the dye base and the mixture applied to the bibulous or absorbent fiber, preferentially adhere to the outer diameter of the fiber forming a conductive mat around the fiber which is fixed after curing.

The following test results were obtained: 1) electrical; and 2) optical transmittance and surface roughness.

Resistivity in Comparative Ink and Dye Matrixes.

Background:

To impart the conductive path throughout a structure, a three-dimensional network of filler particles is required. This is referred to as percolation threshold and is characterized by a large change in the electrical resistance. Essentially, the theory is based on the agglomeration of particles, and particle-to-particle interactions resulting in a transition from isolated domains to those forming a continuous pathway through the material. Nanotubes have a much lower percolation threshold than typical fillers due to their high aspect ratio of >1000 and high conductivity. As an example, the calculated percolation threshold for carbon black is 3-4% while for typical carbon nanotubes the threshold is below 0.04%, or two orders of magnitude lower. This threshold value is one of the lowest ever calculated and confirmed. (See J. Sandler, M. S. P. Shaffer, T. Prasse, W. Bauhofer, A. H. Windle and K. Schulte, “Development of a dispersion process for catalytically grown carbon nanotubes in a epoxy matrix and the resulting electrical properties”, University of Cambridge, United Kingdom, and the Technical University Hamburg-Hamburg, Germany).

The high conductivity imparted when nanotubes are dispersed in an ink or dye at low concentrations (0.05 to 20-wt. %) is not typically observed in a conductive coating. This is one of the most attractive aspects to using nanotubes to make conductive coatings. A more common example is found in conductive inks and coatings used in the electronics industry were polymers and other carriers are filled with carbon black to a loading of 10 to 30%-by weight.

The high conductivity at low concentrations for inks and coatings made from carbon nanotubes is due to the extraordinarily high aspect ratio of carbon nanotubes and the high tube conductivity. In fact, the electrical conductivity of individual tubes has been measured and determined to exhibit metallic behavior. The curing, formulation and processing of the invention enhances the formation of ropes into a mat when the carbon nanotubes are applied and cured properly. This curing process improves the conductivity when using lower percentages of carbon nanotubes.

Electrical Resistivity.

To demonstrate electrical resistivity, samples of each conductive mixture were coated onto the appropriate substrate. The inks were coated onto polyester and the dye was coated onto linen. The results are shown in Table 1-5. The results indicate that electrical resistivity of the conductive inks are sensitive to whether the carbon nanotubes are applied as a separate layer, applied as part of dispersion in the polymer binder and the curing process. The conductive dye shows excellent conductive properties when coated on linen and cured properly.

Summary of Electrical Test Results.

Inks or dyes of the invention have electrical resistivity much lower than required for Electric Static Discharge (ESD) applications and can be easily designed for any level of electrical resistance above a 100 Ohms/sq. using a very low loading level of nanotubes.

Optical Transmittance.

Carbon nanotubes are excellent additives to impart conductivity and consequently function well in an ESD role. However, for application to be properly used in co-pending provisional applications U.S. 60/546,762 strip electrode with conductive nanotube printing and U.S. 60/652,111 Taser personnel armor and co-pending application Ser. No. 11/029,270 Security marking and security mark, the coatings need to be highly conductive, translucent and have a smooth surface morphology. Samples of each conductive ink printed on polyester for the comparative test matrix were tested using ASTM D 1003 “Standard Test Method for Haze and Luminous Transmittance of Transparent Plastics”. This test method covers the evaluation of specific light-transmitting and wide-angle-light-scatter-ring properties of planar sections of materials such as essentially transparent plastic. A procedure is provided for the measurement of luminous transmittance (% T). This data is presented in the Table 1-4 below. For comparison, the same conductive inks and coatings were tested for % T at fixed frequency of 500 nm using a Beckman UV-Vis spectrometer on the polyester with the conductive ink containing carbon nanotubes and different curing times and temperatures, see Table 1-4.

Polyester conductive ink printed substrates were made with carbon nanotubes bearing inks at 0.025 mils thick or less. The samples were tested on the UV-V is spectrometer for percent transmission at 500 nm, an industry standard for comparison. The samples tested were a two layer conductive coating and a single layer conductive coating. In both cases the polymer binder used was polyurethane or Electrodag—PF 427 which has an antimony tin-oxide conductive component. Table 1 presents the optical and resistivity data for these samples printed on polyester with conductive ink. Looking at the same experimental cases tested in Table 1 and examining different curing times and temperatures, the results are shown in Tables 2, 3, 4. It is evident that the curing process is important to attain suitable conductivity, luminous transmittance and haze. Above 100 degrees C. or curing for 30 minutes at 95 degree C. the polyester conductive ink and coating was compromised and no readings were possible so those results are not tabulated.

Table 5 provides the result of a dye system modified to be conductive and the results when cured at different temperatures and curing times. As can be seen the curing time and curing temperature have a significant effect on the conductivity of the dye dispersion when printed on linen.

Surface roughness was measured with an Optical Profilometer.

TABLE 1
Coatings on polyester conductive ink and coating
cured for 20 minutes at 95 degrees C.

| | % T @ 500 nm | Ohms/Sq. | RMS in nm |
|---|---|---|---|
| Two layer conductive coating | 77.3% | 10,000 | 44 |
| with 1% carbon nanotubes and polyurethane polymer | | | |
| Single layer conductive coating | 75.2 | 15,000 | 45 |
| with 1% carbon nanotubes and polyurethane polymer | | | |
| Two layer conductive coating | 71.3 | 8000 | 62 |
| with 1% carbon nanotubes and Electrodag - PF 427 | | | |
| Single layer conductive coating | 70.2 | 7500 | 68 |
| with 1% carbon nanotubes and Electrodag - PF 427 | | | |
| Two layer conductive coating | 80.3% | 1.0 × 10⁸ | 41 |
| with 0.1% carbon nanotubes and polyurethane polymer | | | |
| Polyester no coating or ink | 95% | Not conductive | 40 |

TABLE 2
Coatings on polyester conductive ink and coating
cured for 10 minutes at 95 degrees C.

| | % T @ 500 nm | Ohms/Sq. | RMS in nm |
|---|---|---|---|
| Two layer conductive coating | 74.1% | 75,000 | 46 |
| with 1% carbon nanotubes and polyurethane polymer | | | |
| Single layer conductive coating | 70.3 | 90,000 | 47 |
| with 1% carbon nanotubes and polyurethane polymer | | | |
| Two layer conductive coating | 69.1 | 70000 | 64 |
| with 1% carbon nanotubes and Electrodag - PF 427 | | | |
| Single layer conductive coating | 60.8 | 1.0 × 10⁸ | 66 |
| with 1% carbon nanotubes and Electrodag - PF 427 | | | |
| Two layer conductive coating | 80.4% | 1.0 × 10⁹ | 43 |
| with 0.1% carbon nanotubes and polyurethane polymer | | | |
| Polyester no coating or ink | 95% | Not conductive | 40 |

TABLE 3
Coatings on polyester conductive ink and coating
cured for 20 minutes at 70 degrees C.

| | % T @ 500 nm | Ohms/Sq. | RMS in nm |
|---|---|---|---|
| Two layer conductive coating | 71.7% | 1.0 × 10⁸ | 49 |
| with 1% carbon nanotubes and polyurethane polymer | | | |
| Single layer conductive coating | 68.2 | not conductive | 44 |
| with 1% carbon nanotubes and polyurethane polymer | | | |
| Two layer conductive coating | 67.6 | not conductive | 70 |
| with 1% carbon nanotubes and Electrodag - PF 427 | | | |
| Single layer conductive coating | 64.9 | not conductive | 77 |
| with 1% carbon nanotubes and Electrodag - PF 427 | | | |
| Two layer conductive coating | 80.0% | not conductive | 46 |
| with 0.1% carbon nanotubes and polyurethane polymer | | | |
| Polyester no coating or ink | 95% | not conductive | 40 |

TABLE 4
Coatings on polyester conductive ink and coating
cured for 20 minutes at 45 degrees C.

| | % T @ 500 nm | Ohms/Sq. | RMS in Nm |
|---|---|---|---|
| Two layer conductive coating | 64.2% | not conductive | 53 |
| with 1% carbon nanotubes and polyurethane polymer | | | |
| Single layer conductive coating | 59.1 | not conductive | 59 |
| with 1% carbon nanotubes and polyurethane polymer | | | |
| Two layer conductive coating | 55.3 | not conductive | 81 |
| with 1% carbon nanotubes and Electrodag - PF 427 | | | |
| Single layer conductive coating | 60.2 | not conductive | 78 |
| with 1% carbon nanotubes and Electrodag - PF 427 | | | |
| Two layer conductive coating | 70.0% | not conductive | 47 |
| with 0.1% carbon nanotubes and polyurethane polymer | | | |
| Polyester no coating or ink | 95% | not conductive | 40 |

TABLE 5
Dye system modified with conductive carbon nanotubes.

| Curing time and temperature | Ohms/Sq. |
|---|---|
| Cured for 20 minutes at 95 degrees C. | 115,000 |
| Cured for 10 minutes at 95 degrees C. | 55,000 |
| Cured for 20 minutes at 70 degrees C. | not conductive |
| Cured for 20 minutes at 45 degrees C. | not conductive |

Summary of Optical Test Results.

The optical testing of these samples in the test matrix demonstrates excellent transmission with low loss and good resistivity data when cured properly. The results of thin coatings and bi-layer experiments where optical properties were the focus were (<80% T) for the conductive inks and coatings.

ESD Conductive Inks and Coatings

It is possible to obtain a highly absorbant coating by increasing the nanotube concentration. A 10% loading level of multi-walled nanotubes in matrix is dull in appearance and has a rough surface morphology of approximately 130 nm when measured with an Optical Profilometer. In contrast, an 8-micron thick polymer coating loaded with 0.5% carbon nanotubes is still conductive and the surface morphology is approximately 41 nm when measured with an Optical Profilometer. A suitable coating was formed by coating with 0.3% carbon nanotubes @ 0.00025 inch final thickness. It has a resistivity of 10⁸ Ohms sq with slight grey coloration and 70% T and a surface morphology of approximately 32 nm when measured with an Optical Profilometer. This excellent coating demonstrates that by manipulating the concentration and coating thickness excellent surface roughness, optical and electrical properties can be obtained when cured properly. However when the curing parameters are varied from the optimal the optical, surface morphology and electrical properties are not suitably achieved.

Although only a few exemplary embodiments of the present invention have been described in detail in this disclosure, those skilled in the art who review this disclosure will readily appreciate that many modifications are possible in the exemplary embodiments (such as variations in sizes, structures, shapes and proportions of the various elements, values of parameters, or use of materials) without materially departing from the novel teachings and advantages of the invention. Accordingly, all such modifications are intended to be included within the scope of the invention as defined in the appended claims.

Other substitutions, modifications, changes and omissions may be made in the design, operating conditions and arrangement of the preferred embodiments without departing from the scope of the invention as expressed in the appended claims.

Additional advantages, features and modifications will readily occur to those skilled in the art. Therefore, the invention in its broader aspects is not limited to the specific details, and representative devices, shown and described herein. Accordingly, various modifications may be made without departing from the scope of the general inventive concept as defined by the appended claims and their equivalents.

All references cited herein, including all U.S. and foreign patents and patent applications, all priority documents, all publications, and all citations to government and other information sources, are specifically and entirely hereby incorporated herein by reference. It is intended that the specification and examples be considered exemplary only, with the true scope of the invention indicated by the following claims.

As used herein and in the following claims, articles such as “the”, “a” and “an” can connote the singular or plural.

What is claimed is:

1. A wet dispersion that is dispersed in a coating or ink comprising of a plurality of nanotubes with an outer diameter of less than 20 nm, said carbon nanotubes consisting of less than 10 percent by weight of the wet dispersion which is applied to a substrate as a wet dispersion and cured at a temperature of at least 75 degrees C. for a minimum of 10 minutes so that the resulting cured coating or ink is conductive and has a surface morphology of less than about 100 nm when compared to the base surface morphology.

2. The wet dispersion of claim 1, wherein said nanotubes have an outer diameter of about 0.5 to 10 nm.

3. The dispersion of claim 1, wherein said dispersion is formed from a conductive carbon nanotubes which includes as part of the formulation carbon nanotubes, carbon nanotubes/antimony tin oxide, carbon nanotubes/platinum, or carbon nanotubes/silver or carbon nanotubes/silver-chloride.

4. The dispersion of claim 1, wherein said carbon nanotubes are selected from the group consisting of single-walled nanotubes, double-walled nanotubes (DWNTs), multi-walled nanotubes (MWNTs), and mixtures thereof.

5. The dispersion of claim 1, wherein said dispersion when applied to a substrate and cured has a differential surface morphology less than 90 nm when compared to the base material surface morphology.

6. The dispersion of claim 1, wherein said carbon nanotubes are present in said dispersion at about 0.001 to about 10% based on weight.

7. The dispersion of claim 1, wherein said carbon nanotubes are present in said dispersion at about 0.05%.

8. The dispersion of claim 1, wherein the dispersion has a surface resistance in the range of less than about 10.0×10¹⁰ ohms/square after it is applied to a substrate and cured.

9. The dispersion of claim 1, wherein the dispersion has a surface resistance in the range of about 1.0×10²−10.0×10¹⁰ ohms/square after it is applied to a substrate and cured.

10. The dispersion of claim 1, wherein the dispersion results in a coating or ink that has a surface roughness between 20 and 90 nm after it is applied to a substrate and cured.

11. The dispersion of claim 1, wherein the dispersion has a surface resistance in the range of less than about 10.0×10³ ohms/square after it is applied to a substrate and cured.

12. The dispersion of claim 1, wherein the dispersion has a volume resistance in the range of about 10.0×10² ohms-cm to about 10.0×10¹⁰ ohms-cm after it is applied to a substrate and cured.

13. The dispersion of claim 1, where at least one component is a solvent selected from either organic or inorganic solvents.

14. The dispersion of claim 1, wherein the dispersion forms at least one component of a coating or ink.

15. The dispersion of claim 1, further comprising a polymeric material, wherein the polymeric material comprises a material selected from the group consisting of thermoplastics, thermosetting polymers, elastomers, conducting polymers and combinations thereof.

16. The dispersion of claim 1, further comprising a polymeric material, wherein the polymeric material comprises a material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides, ceramic hybrid polymers, phosphine oxides and chalcogenides and mixtures thereof.

17. The dispersion of claim 1, further comprising a polymeric material containing conductive inorganic materials, wherein the conductive inorganic materials may selected from aluminum, antimony, beryllium, cadmium, chromium, cobalt, copper, doped metal oxides, iron, gold, lead, manganese, magnesium, mercury, metal oxides, nickel, platinum, silver, steel, titanium, zinc, tin-indium mixed oxide, antimony-tin mixed oxide, fluorine-doped tin oxide, aluminum-doped zinc oxide and combinations and mixtures thereof.

18. The dispersion of claim 1, further comprising a polymeric material wherein the carbon nanotubes are dispersed substantially homogenously throughout the polymeric material.

19. The dispersion of claim 1, wherein the carbon nanotubes are present in a gradient fashion after it is applied to a substrate and cured.

20. The dispersion of claim 1, wherein the carbon nanotubes are present on a surface of said coating or ink after it is applied to a substrate and cured.

21. The dispersion of claim 1, wherein the carbon nanotubes are formed in an internal layer of said coating or ink after it is applied to a substrate and cured.

22. The dispersion of claim 1, wherein a step of applying the dispersion comprises a method selected from the group consisting of spray painting, dip coating, spin coating, knife coating, kiss coating, gravure coating, screen printing, stenciling, ink jet printing, and pad printing and then curing the application using heat for a specific time.

23. The dispersion of claim 1, further comprising an additive selected from the group consisting of a dispersing agent, surfactant, a binder, a cross-linking agent, a stabilizer agent, a coloring agent, a UV absorbent agent, and a charge adjusting agent.

24. The dispersion of claim 1, wherein the dispersion has a total transmittance of at least about 60% after it is applied to a substrate and cured.

25. The dispersion of claim 1, wherein said dispersion has surface roughness difference of less than 90 nm when compared to the surface roughness of the base material after it is applied to a substrate and cured.

26. The dispersion of claim 1, wherein said dispersion has a thickness between about 0.5 nm to about 1000 micron after it is applied to a substrate and cured.

27. The dispersion of claim 1, wherein said dispersion has a thickness between about 0.05 to about 500 microns after it is applied to a substrate and cured.

28. The dispersion of claim 1, wherein the carbon nanotubes are oriented after it is applied to a substrate and cured.

29. The dispersion of claim 1, wherein the carbon nanotubes are oriented in the plane of the dispersion after it is applied to a substrate and cured.

30. The dispersion of claim 1, wherein the carbon nanotubes are oriented, further comprising an additional layer of oriented carbon nanotubes.

31. A method for making an electrically conductive dispersion of claim 1 comprising: providing a plurality of carbon nanotubes with an outer diameter of less than 20 nm, applying the carbon nanotube dispersion on a surface of a substrate and then curing the dispersion using heat and time to form the carbon nanotubes into a conductive mat that has a surface roughness difference of less than 90 nm when compared to the surface roughness of the base material.

32. The method of claim 31, wherein the step of applying the dispersion comprises a method selected from the group consisting of spray painting, dip coating, spin coating, knife coating, kiss coating, gravure coating, screen printing, stenciling, ink jet printing, and pad printing and then curing the application using heat for a specific time.

33. The method of claim 31, wherein said carbon nanotubes have an outer diameter of about 0.5 to 20 nm.

34. The method of claim 31, wherein said carbon nanotubes are selected from the group consisting of single-walled carbon nanotubes, double-walled Carbon nanotubes (DWNTs), multi-walled carbon nanotubes (MWNTs), and mixtures thereof.

35. The method of claim 31, wherein said carbon nanotubes are substantially single-walled Carbon nanotubes.

36. The method of claim 31, wherein the dispersion has a volume resistances in the range of about 10.×10⁻² ohms/cm to about 10.×10¹⁰ ohms/cm after it is applied to a substrate and cured.

37. The method of claim 31, further comprising orienting the carbon nanotubes by curing of the dispersion after it is applied to a substrate for a minimum of 10 minutes at a temperature of at least 75 degrees C.

38. A multi-layered structure comprising of a layer formed from a non conductive substrate, an electrically conductive dispersion of carbon nanotubes with an outer diameter of less than 20 nm, and a polymeric layer disposed on at least a portion of said electrically conductive dispersion where as the multi-layer structure has a differential surface roughness compared to the substrate of less than 90 nm after it is applied to a substrate and cured.

39. The multi-layered structure of claim 38, wherein said carbon nanotubes have an outer diameter of about 0.5 to 20 nm.

40. The multi-layered structure of claim 38, wherein said carbon nanotubes are selected from the group consisting of single-walled carbon nanotubes, double-walled Carbon nanotubes (DWNTs), multi-walled carbon nanotubes (MWNTs), and mixtures thereof.

41. The multi-layered structure of claim 38, wherein said carbon nanotubes are substantially single-walled Carbon nanotubes.

42. The multi-layered structure of claim 38, wherein said carbon nanotubes are present in said dispersion at about 0.001 to about 10% based on weight.

43. The multi-layered structure of claim 38, wherein the dispersion has volume resistances in the range of about 10.×10⁻² ohms/cm to about 10.×10¹⁰ ohms/cm after it is applied to a substrate and cured.

44. The multi-layered structure of claim 38, wherein the dispersion is applied to a substrate to form a ink or coating.

45. The multi-layered structure of claim 38, further comprising a polymeric material, wherein the polymeric material comprises a material selected from the group consisting of thermoplastics, thermosetting polymers, elastomers, conducting polymers and combinations thereof.

46. The multi-layered structure of claim 38, further comprising a polymeric material, wherein the polymeric material comprises a material selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides, ceramic hybrid polymers, phosphine oxides and chalcogenides and mixtures thereof and the conductive inorganic materials may comprise particles of aluminum, antimony, beryllium, cadmium, chromium, cobalt, copper, doped metal oxides, iron, gold, lead, manganese, magnesium, mercury, metal oxides, nickel, platinum, silver, steel, titanium, zinc, tin-indium mixed oxide, antimony-tin mixed oxide, fluorine-doped tin oxide, aluminum-doped zinc oxide or combinations or mixtures thereof.

47. The multi-layered structure of claim 38, further comprising a polymeric material wherein the carbon nanotubes are dispersed substantially homogenously throughout the polymeric material.

48. The multi-layered structure of claim 38, further comprising a polymeric material wherein the carbon nanotubes are present in a gradient fashion.

49. The multi-layered structure of claim 38, wherein the carbon nanotubes are present on a surface of said coating or ink after it is applied to a substrate and cured.

50. The multi-layered structure of claim 38, wherein the carbon nanotubes are formed in an internal layer of said coating or ink after it is applied to a substrate and cured.

51. The multi-layered structure of claim 38, where the dispersion of carbon nanotubes is formed with inorganic or organic solvents.

52. The multi-layered structure of claim 38, further comprising an additive selected from the group consisting of a dispersing agent, surfactant, a binder, a cross-linking agent, a stabilizer agent, a coloring agent, a UV absorbent agent, and a charge adjusting agent.

53. The multi-layered structure of claim 38, wherein the coating has a total transmittance of at least about 60% but less than 80% and a resulting differential surface morphology of less than 90 nm.

54. The multi-layered structure of claim 38, wherein said coating has a thickness between about 0.005 to about 1,000 microns.

55. The multi-layered structure of claim 38, wherein the carbon nanotubes are oriented.

56. The multi-layered structure of claim 38, wherein the carbon nanotubes are oriented in the plane of the coating and the coating is cured a minimum of 10 minutes at 95 degrees C. to orient the conductive organic material into a conductive mat.

57. A dispersion of carbon nanotubes comprising a plurality of carbon nanotubes with an outer diameter of less than 20 nm that forms a conductive layer on the outside of a bibulous fiber when applied to the bibulous fiber and cured.

58. The dispersion of claim 57, wherein said carbon nanotubes have an outer diameter of about 0.5 to 10 nm.

59. The dispersion of claim 57, wherein said carbon nanotubes are selected from the group consisting of single-walled Carbon nanotubes, double-walled carbon nanotubes (DWNTs), multi-walled carbon nanotubes (MWNTs), and mixtures thereof.

60. The dispersion of claim 57, wherein said carbon nanotubes are substantially single-walled carbon nanotubes.

61. The dispersion of claim 57, where after coating the bibulous fiber the dye is cured a minimum of 20 minutes at 95 degrees C. to orient the conductive organic material into a conductive mat.

62. The dispersion of claim 57, further comprising of carbon nanotubes and conductive inorganic materials selected from aluminum, antimony, beryllium, cadmium, chromium, cobalt, copper, doped metal oxides, iron, gold, lead, manganese, magnesium, mercury, metal oxides, nickel, platinum, silver, steel, titanium, zinc, tin-indium mixed oxide, antimony-tin mixed oxide, fluorine-doped tin oxide, aluminum-doped zinc oxide or combinations or mixtures thereof.

63. The dispersion of claim 57, further comprising conductive organic materials, inorganic materials, or combinations or mixtures thereof.

64. The dispersion of claim 63 wherein the conductive organic materials are selected from the group consisting of buckeyballs, carbon black, fullerenes, carbon nanotubes with an outer diameter of greater than about 10 nm, and combinations and mixtures thereof and the coating is cured a minimum of 10 minutes at 75 degrees C. to orient the conductive organic material into a conductive mat.

65. The dispersion of claim 63 wherein the conductive inorganic materials are selected from the group consisting of aluminum, antimony, beryllium, cadmium, chromium, cobalt, copper, doped metal oxides, iron, gold, lead, manganese, magnesium, mercury, metal oxides, nickel, platinum, silver, steel, titanium, zinc, and combinations and mixtures thereof.

66. The dispersion of claim 57, further comprising a conductive material selected from the group consisting of tin-indium mixed oxide, antimony-tin mixed oxide, fluorine-doped tin oxide, aluminum-doped zinc oxide and combinations and mixtures thereof.

67. The dispersion of claim 57, further comprising conductors, fluids, gelatins, ionic compounds, semiconductors, solids, surfactants, dyes, or combinations or mixtures thereof.

68. The dispersion of carbon nanotubes less than 20 nm in diameter formulated with solvents and the method of refining the carbon nanotube mix using flocculation methods to refine mixture and applying the dispersion to a substrate and curing it such that the differential surface roughness is less than 90 nm.

69. The dispersion of claim 68 containing materials secondary materials including organic conductive materials, inorganic conductive materials, polymers and dyes.

70. A dispersion of claim 68 where the carbon nanotube mixture is refined by flocculation to form an agglomeration of destabilized particles into micro floc and after into bulky floccules which can be settled.

71. A dispersion of claim 68 where the floc is formed by the addition of another reagent called flocculant or a flocculant that aids in the formation of the floc.

72. A dispersion of claim 68 where the floc is formed by the adjusting the velocity gradient, the time, and the pH of the mixture.

73. A dispersion of claim 68 where the floc is formed by to refine the carbon nanotube mix by first heating the mixture to 70 degrees C. so that the carbon nanotubes flocculate to the bottom of the container when subjected to centrifuging or extended settling time.

74. A dispersion of claim 68 where the floc is formed by the addition of MgCL₂ or NACL or nano size metals such as platinum, iron, copper, gold or silver to the mixture to promote the flocculation and refinement of the carbon nanotubes.

75. A means of patterning a conductive coating formed by a dispersion of carbon nanotubes by selectively curing areas of the applied dispersion so as to form conductive and non conductive regions.

76. An ink for an electrically-conductive coating, said ink comprising:
carbon nanotubes, said carbon nanotubes having an average outer diameter of less than about 20 nm and consisting of less than about 10 wt. % of a total mass of said ink;
a carrier in which said carbon nanotubes are dispersed, said carrier comprising a solvent selected from the group consisting of alcohols, nitrites, hexane, heptane, ketones, water, ethers, and combinations of the foregoing; and
a dispersing agent;
wherein said ink, when deposited as a coating, has a differential surface morphology of less than about 100 nm and a surface resistance of less than about 10.0×10¹⁰ ohms/square.

77. The ink of claim 76, wherein said dispersing agent is a surfactant.

78. The ink of claim 76, wherein said dispersing agent is selected from the group consisting of sorbitan, fatty acid esters of sorbitan, celluloses, non-ionic detergent ethers, oxide compounds, and combinations of the foregoing.

79. The ink of claim 76, wherein a population of said carbon nanotubes is centrifuged out of said carrier.

80. The ink of claim 76, wherein a population of said carbon nanotubes is separated from said carrier by flocculation.

81. The ink of claim 76, wherein said carbon nanotubes are alloyed with an oxide selected from the group consisting of tin-indium mixed oxides, antimony-tin mixed oxides, fluorine-doped tin oxides, aluminum-doped tin oxides, zinc oxides, and combinations of the foregoing.

82. An ink for an electrically-conductive coating, said ink comprising:
carbon nanotubes, said carbon nanotubes having an average outer diameter of less than about 20 nm and consisting of less than about 10 wt. % of a total mass of said ink; and
a polymeric material selected from the group consisting of natural and synthetic polymeric resins;
wherein said ink, when deposited as a coating, has a differential surface morphology of less than about 100 nm and a surface resistance of less than about 10.0×10¹⁰ ohms/square.

83. The ink of claim 82, wherein said polymeric material is selected from the group consisting of thermoplastics, thermosetting polymers, elastomers, and combinations of the foregoing.

84. The ink of claim 82, wherein said polymeric material is selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides, combinations of the foregoing, ceramic hybrid polymers, phosphine oxides, and chalcogenides.

85. The ink of claim 82, wherein said carbon nanotubes are alloyed with an oxide selected from the group consisting of tin-indium mixed oxides, antimony-tin mixed oxides, fluorine-doped tin oxides, aluminum-doped tin oxides, zinc oxides, and combinations of the foregoing.

86. An electrically-conductive laminate structure for distributing an electrical charge, said laminate structure, comprising:
at least one layer of carbon nanotube material, said carbon nanotube material comprising carbon nanotubes having an average outer diameter of less than about 20 nm; and
a coating of polymeric material overcoated onto said at least one layer of carbon nanotube material;
wherein said carbon nanotube material, when deposited as said layer, has a differential surface morphology of less than about 100 nm and a surface resistance of less than about 10.0×10¹⁰ ohms/square.

87. The laminate structure of claim 86, wherein said carbon nanotube material includes an oxide selected from the group consisting of tin-indium mixed oxides, antimony-tin mixed oxides, fluorine-doped tin oxides, aluminum-doped tin oxides, zinc oxides, and combinations of the foregoing.

88. The laminate structure of claim 86, wherein said carbon nanotube material includes silicon.

89. The laminate structure of claim 86, wherein said polymeric material is selected from the group consisting of polyethylene, polypropylene, polyvinyl chloride, styrenic, polyurethane, polyimide, polycarbonate, polyethylene terephthalate, cellulose, gelatin, chitin, polypeptides, polysaccharides, polynucleotides, and combinations of the foregoing.

90. The laminate structure of claim 86, further comprising platinum nano-sized particles incorporated into said coating.
